(19) United States
(12) Patent Application Publication
(10) Pub. No.: US 2009/0228318 A1
(43) Pub. Date: Sep. 10, 2009

(54) Server and sensor net system for measuring quality of activity

(75) Inventors: Koji Ara, Higashiyamato (JP); Kazuo Yano, Hino (JP); Nobuo Sato, Saitama (JP); Satomi Tsuji, Kokubunji (JP); Norihiko Moriwaki, Hino (JP)

Correspondence Address: Juan Carlos A. Marquez;c/o Stites & Harbison PLLC, 1199 North Fairfax Street, Suite 900, Alexandria, VA, 22314-1437, US

(73) Assignee: Hitachi, Ltd.

(21) Appl. No.: 12/320,406

(22) Filed: Jan. 26, 2009

(30) Foreign Application Priority Data
Mar. 6, 2008 (JP) 2008-055698

(51) Int. Cl. G06Q 10/00; H04B 3/58

(52) U.S. Cl. 705/7; 455/7

(57) ABSTRACT

In a real environment, it is grasped in what condition the worker has conducted the activity, and in what condition the worker has created a file, and the quality of the entire activity from the activity start to the activity end is provided as an index. An action index indicative of an action state of the worker who operates a computer is calculated, and the action index is associated with a specific activity of the worker as activity quality information representative of the quality of activity.

### CLAIM OF PRIORITY

The present application claims priority from Japanese patent application JP 2008-055698 filed on Mar. 6, 2008, the content of which is hereby incorporated by reference into this application.

### FIELD OF THE INVENTION

The present invention relates to a technique for measuring the condition and activity of a worker, and the quality of an electronic file created by the worker, and more particularly to a technique for measuring the quality by the aid of a sensor mounted device which conducts the intermittent operation of repeating a start state and a stop state at regular time intervals for saving power.

### BACKGROUND OF THE INVENTION

A window name, an application name, the number of types or timing of a keyboard, a travel distance of a mouse, and a file name are logged from a PC.

Also, JP-A 2007-94457 discloses a technique by which analysis is executed by obtaining information on physical operation and information on the operation of an information processing device. In the technique, brain waves or the line of sight is obtained as the physical activity information, and information on page transition of a homepage is obtained as an event queue. It is checked from the even queue whether the same activity is not repetitively conducted, or not, or whether activity stops on a certain screen, or not, thereby conducting a usability test as to whether the configuration or showing of a homepage is inconvenient to the worker, or not.

On the other hand, in recent years, a network system (hereinafter referred to as “sensor net system”) has been studied in which a downsized electronic circuit having a wireless communication function is added to a sensor to take diverse information of an actual world into the information processing device at real time. Wide application has been proposed in the sensor net system. For example, there has been also proposed a medicine application in which a pulse or the like is always monitored by a radio circuit, a processor, a sensor, or a downsized electronic circuit of a ring type into which a radio circuit, a processor, a sensor, and a battery are integrated. A monitor result is sent to a diagnosis device through a wireless communication, and a health condition is determined on the basis of the monitor result.

In recent years, there has been increasingly developed a sensor net system made up of a downsized sensor node (hereinafter referred to as “sensor node”) in which a sensor function is mounted, a repeater, a base station, and a sensor net management server (hereinafter referred to as “management server”). The sensor node observes a condition of a person, a location, or the like (sensor data), relays the observed sensor data to a multihop through a relay station, and then transmits the relayed data to the management server through the base station. The management server executes diverse processing on the basis of the received sensor data.

A key device in the sensor net system is a senor node having a feature that the size is small, and electric power is small. Because the size is small, it is possible to fit the sensor node to something including an environment and a person because of the small size. The sensor node can be driven by a battery for several years without feeding a power from the external. An effort of wearing the sensor node by a person is being surely advanced, and a product of a bracelet type for always measuring a pulse or a temperature, and a product of a name tag type for measuring a face-to-face communication quantity and a speech quantity between persons by means of infrared rays have been advancingly studied.

A characteristic operation of the sensor node includes intermittent operation. In the intermittent operation, necessary hardware is driven only at the time of executing a task such as sensing or data transmission, and a microcomputer, a radio frequency circuit (RF), or the like is rested in a low power mode when there is no task to be executed. The execution of the intermittent operation enables a sensor node to execute the operation for a long period of time under a limited battery.

When a microcomputer expires a given rest period, a timer unit generates interrupt to return the microcomputer to a normal operation mode. According to a given procedure, sensing is executed, sensed data is sent, and the data is received by polling when there is data addressed to the subject microcomputer to process the data. When all of the tasks to be executed at that time point have been completed, the microcomputer is again rested for a given period of time. Since a length of a task processing period between the rest periods is several tens of milliseconds to about 1 second at the longest, the sensor node is in the rest condition over most of time.

Since the basic feature of the intermittent operation resides in that “rest is executed when it is unnecessary to execute the task”, diverse changes are proposed in a method of implementing the intermittent operation according to a method of scheduling the task. For example, when the sensor node has plural sensors, each of the sensors can be provided with a separate sensing cycle. Also, since each of sensing, data transmission, and data reception is naturally an independent task, each of the tasks can be provided with independent operation cycle.

As a method of receiving a command from a management server in the sensor node that thus conducts the interrupt operation, there is a polling system that periodically asks a transmission source whether there is a command addressed to the subject microcomputer, or not. In this case, because a signal with no command is sent without polling by the sensor node per se, the sensor node can conduct the operation according to an intermittent operation cycle thereof. In the case of ZigBee being a wireless communication system used in the sensor net, a period of time between the transmission of an inquiry packet in polling and the reception of a response to the transmission is about 10 ms in total. Therefore, even if polling is implemented in a condition where there is no data, an increase in the power consumption accompanied by rolling is extremely slight.

### SUMMARY OF THE INVENTION

A technique of logging a window name, an application name, the number of types or timing of a keyboard, a travel distance of a mouse, and a file name from a PC is to be measured in operation within a computer operated by a person. For that reason, in a real environment, it is not understood what is a condition in which a worker conducts the activity, or what is a condition in which a file is created. For example, it is impossible to know how much a certain file is concentrically created, how many other persons the worker conducts a face-to-face communication with when the file is created, how much the worker makes a positive statement in the face-to-face communication, how much is a cohesion with members of a team, or what is a role of the communication in an organization. The certain file may be concentratedly created after the worker has united with the team members and densely discussed therewith. Also, other files may be simply created while the worker has a chat with other persons with hardly speaking to the team members. However, it is impossible to determine the quality of the activity.

JP-A 2007-94457 discloses a technique of treating a portion where the same operation is repeated from a specific event train, a portion where a certain activity state continues for a given period of time or longer as an operational trouble to extract those portions. As for the state of the worker per se, it is merely determined whether the worker is at rest, or not, or whether the degree of concentration or a tension of the worker is decreased, or not, as the event. Thus, to locate the source of trouble is effective, but it is impossible to provide the quality of the entire activity from the activity start to the activity end described above as an index.

Under the above circumstances, a problem to be solved by the invention is to grasp in what condition the worker has conducted the activity in the real environment, in what condition the worker has created the file, and provides the quality of the entire activity from the activity start to the activity end as an index.

In the case of solving the above problem by the aid of the activity information of the worker which is acquired from a computer (PC) and information which is acquired from the sensor net system, there arises the following specific problems. First, there is the necessity of providing a mechanism for identifying the respective workers, sensor devices worn by the workers, and corresponding PCs. Because the same person may use plural PCs, or plural persons may use the same PC, it is necessary to precisely recognize them.

Secondly, in order to make the data of the PCs in association with data of the sensors, it is necessary to identify data taken from both of the PCs and the sensors at the same time in some method. In the sensor device having a battery capacity limited, the intermittent operation is necessary. In the case of conducting the above intermittent operation, in order to synchronize the time, not only there is required a method of adjusting the times of the base station, the relay station, and the sensor node while being aware of the intermittent operation, but also it is necessary to synchronize the time of the PC device.

Thirdly, it is necessary to transform the physical quantity obtained through the sensor into a significant quantity representative of the quality. When raw physical information of the sensor is merely directly associated, it is not understood from the meaning of data by a person what is the condition during activity, and the quality is not known.

Fourthly, it is necessary to make the continuous action of a human in association with the sensor data being fragmentary information which is different in property. The information of the sensor is fragmentary and discontinuous at a certain time when data is obtained. On the contrary, the activity on the PC is continuous activity at a certain time zone. It is necessary to associate the continuous activity and the discontinuous activity which are different in property with each other through some method.

Also, in the real activity, even if a subject file or application can be specified at a certain specified momentary time, plural files are frequently dealt with at the same time, or the plural applications are frequently accessed at the same time, around that time. It is impractical to definitely identify one activity such that a certain activity is conducted from one certain time to another certain time.

The outline of a typical configuration of the invention described in the present specification will be described in brief as follows. The present invention calculates an action index indicative of an action state of a worker who operates a computer, and associates specified activity with the action index as the activity quality information representative of the quality of activity.

According to the present invention, it is possible to record the quality of activity for each of the activity on the PC, or each of files created as a result of the activity. The use of the information enables detailed activity management such as a comparison of performance between the workers, a calculation of compensation for business, or a business improvement of an organization.

### BRIEF DESCRIPTION OF THE DRAWINGS

FIG. 1 is a diagram showing an example of a configuration of a sensor net system according to a first embodiment;

FIG. 2 is a block diagram showing an example of a hardware configuration of a sensor node according to the first embodiment;

FIG. 3 is a block diagram showing an example of a hardware configuration of a relay terminal according to the first embodiment;

FIG. 4 is a block diagram showing an example of a hardware configuration of a base station according to the first embodiment;

FIG. 5 is a block diagram showing an example of a hardware configuration of a base station according to the first embodiment;

FIG. 6 is a block diagram showing an example of a hardware configuration of a base static: according to the first embodiment;

FIG. 7 is a structural diagram showing an example of a table that stores sensor data therein according to the first embodiment;

FIG. 8 is a diagram showing an example of a configuration and data of a worker identification information storage table according to the first embodiment;

FIG. 9 is a flowchart showing an example of setting a real-time clock of the relay terminal according to the first embodiment;

FIG. 10 is a flowchart showing an example of time synchronization of a sensor node and a PC according to the first embodiment;

FIG. 11 is a flowchart showing an example of a method of determining the degree of concentration, activeness, face-to-face, a statement, and positiveness according to the first embodiment;

FIG. 12 is a flowchart showing an example of calculating the cohesion and the betweenness according to the first embodiment;

FIG. 13 is a flowchart showing an example of calculating an activity quantity according to the first embodiment;

FIG. 14 is a diagram showing a screen for displaying the quality of activity according to the first embodiment;

FIG. 15 is a diagram showing a configuration of an entire system according to an embodiment which conducts a quality assessment;

FIG. 16 is a flowchart showing an example of the quality assessment according to an embodiment;

FIG. 17 is a flowchart showing an example of a quality assessment according to an embodiment;

FIG. 18 is a flowchart showing an example of an improvement proposal according to an embodiment;

FIG. 19 is a diagram showing an example of an office layout;

FIG. 20 is a diagram showing an example of an inter-worker network;

FIG. 21 is a diagram showing an example of an office layout;

FIG. 22 is a flowchart showing an example of an improvement proposal according to an embodiment;

FIG. 23 is a flowchart showing an example of an improvement proposal according to an embodiment;

FIG. 24 is a flowchart showing an example of acquiring a subjective assessment at a certain time according to an embodiment;

FIG. 25 is a diagram showing data putting together the subjective assessment and action data at a certain time;

FIG. 26 is a diagram showing an action frequency and mapping of the subjective assessment;

FIG. 27 is a diagram showing a correlation coefficient of the action data and the subjective assessment;

FIG. 28 is a diagram showing an example of a sheet that conducts the subjective assessment;

FIG. 29 is a diagram showing hardware that conducts the subjective assessment;

FIG. 30 is a diagram showing a correlation coefficient of the action data and the subjective assessment of two workers;

FIG. 31 is a diagram showing data that put together the action data and the subjective assessment of the two workers;

FIG. 32 is a diagram showing a correlation coefficient of action data and a subjective assessment of three workers;

FIG. 33 is a diagram showing an example of an influence among the workers;

FIG. 34 is a diagram showing an example of an influence among the workers;

FIG. 35 is a diagram showing an example of a system configuration using the subjective assessment and a business assessment according to an embodiment; and

FIG. 36 is a diagram showing an example of an interface that conducts a comparison of organizations.

### DETAILED DESCRIPTION OF THE PREFERRED EMBODIMENTS

Hereinafter, a description will be given in detail of embodiments of the present invention with reference to the accompanying drawings. The components denoted by the same symbols indicate identical or similar configurations.

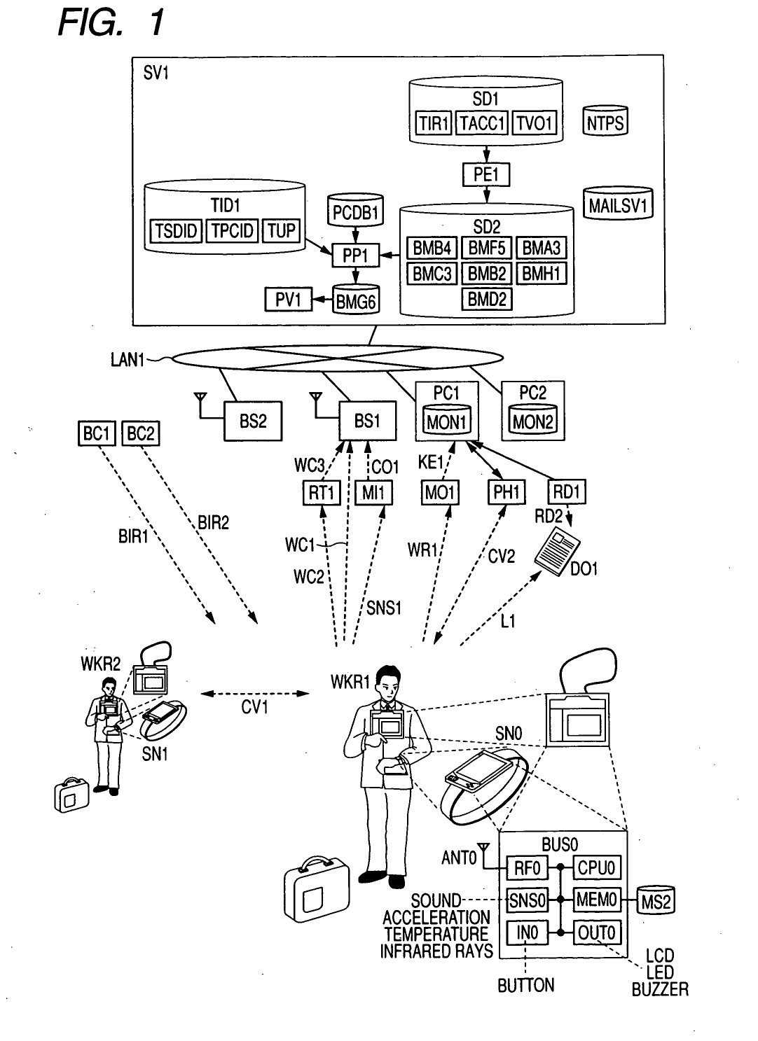

FIG. 1 shows a basic configuration of this system. A worker WKR 1 holds a sensor node SN0 packed into a bracelet or a name tag. The sensor node SN0 includes a processor circuit CPU0, a radio circuit RFO, a sensor SNS0 such as sound, acceleration, temperature, or infrared rays, a memory MEM0 that stores sensing program MS2 therein, a button IN0, and an output device such as an LCD, an LED, or a buzzer. A pulse in the case of the bracelet and opposite faces of infrared devices that face each other in the name tag can be detected by an infrared sensor. That is, when both of the worker WKR1 and another worker WKR2 wear the sensor nodes SNO of the name tag type, and face each other, face-to-face communications of the respective workers can be detected by the sensor node SN0. Information that has been sensed by the sensor node SN0 is sent to a base station device BS1 by means of a wireless communication WC1, or wireless communications WC2 and WC3 via a relay terminal RT1. Information that has been received by the base station BS1 is stored in a sensor database SD1 of a management server SV1 on a wired network LAN1. In the management server 1 are additionally stored a database PCDB 1 of a history of PC operation which has been acquired by PC operation/state monitoring programs MON1 and MON2 that will be described later.

Also, the LAN1 is also connected with computers PC1 and PC2 used by the workers by a wire or a wireless LAN. The computer PC1 is connected with a keyboard KE1 and a mouse MO1 for writing WR1 of a document as well as an IP phone PH1 that conducts a conversation CV2, a bar code/IC tag reader RD1 that executes reading RD2 from a medium DO1 with a bar code/tag by a visual contact L1 of the worker. Likewise, the PC2 may be connected with the same input/output device. In the PC1 and the PC2 are stored the PC operation/state monitoring programs MON1 and MON2.

The base station SB1 is connected with a camera CO1 and a microphone MI1, and the conversation CV1 with another worker WKR2 is sensed SNS1 by the microphone MI1.

Infrared transmitting devices BC1 and BC2 ore devices that transmit infrared rays BIR1 and BIR2 at regular intervals, and are located at a place such as a conference room, a laboratory, or a coffee room. When the worker WKR1 who wears the sensor device SN0 of the name tag type conducts activity in front of the infrared transmitting devices BC1 and BC2, the infrared rays BIR1 and BIR2 can be detected by the sensor node SN0. The information is sent by the wireless communication WC1 to enable the activity places of the respective workers to be known.

Also, in the management server SV1 is stored an NTP server NTPS that manages a time, which cyclically refers to a Standard Time, etc. on the internet to manage a precise time.

A mail server MAILSV1 stores a mail received by the worker and a mail sent by the worker.

A quality index assessment program PE1 calculates a quality such as concentration, activeness, face-to-face, positiveness, a statement, cohesion, or betweenness, and stores the quality in the quality data base SD2. The contents of the respective tables in the SD2 will be described later. The database SD2 on display is separate from the database SD1, but may be stored in the same database. Also, all of the tables are separate on display, but external cohesion can be conducted on the basis of time information to provide one table.

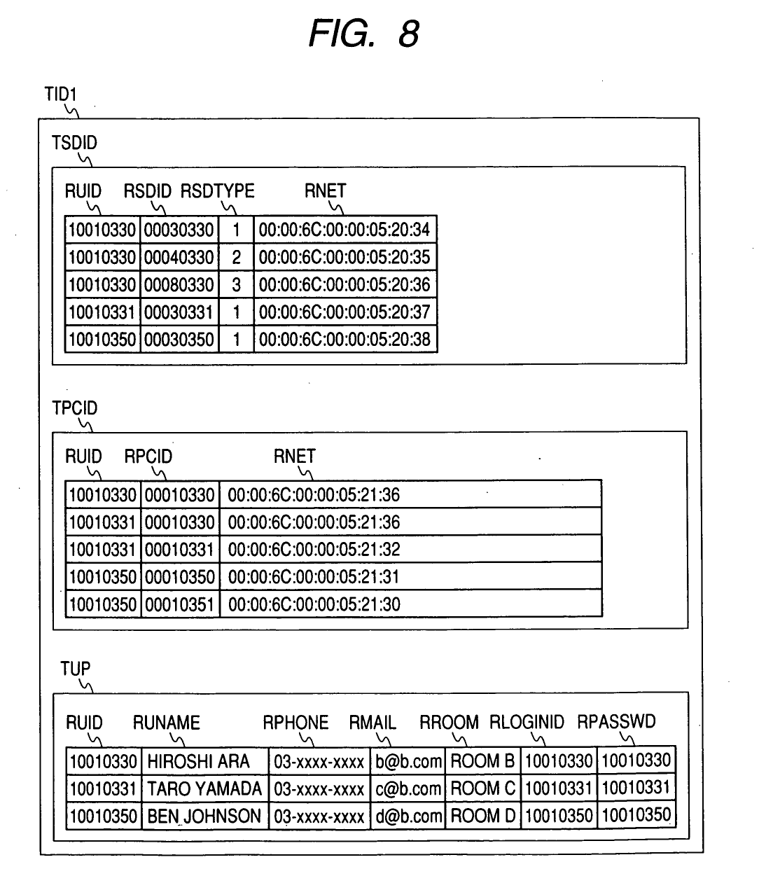

Reference TID1 is a worker identification information storage table that stores identification information for associating the workers, the sensor devices, and the PC devices with each other. In the TID1 are stored a sensor identifier management table TSDID, a PC identifier management table TPCID, and a user profile management table TUP which will be described with reference to FIG. 8.

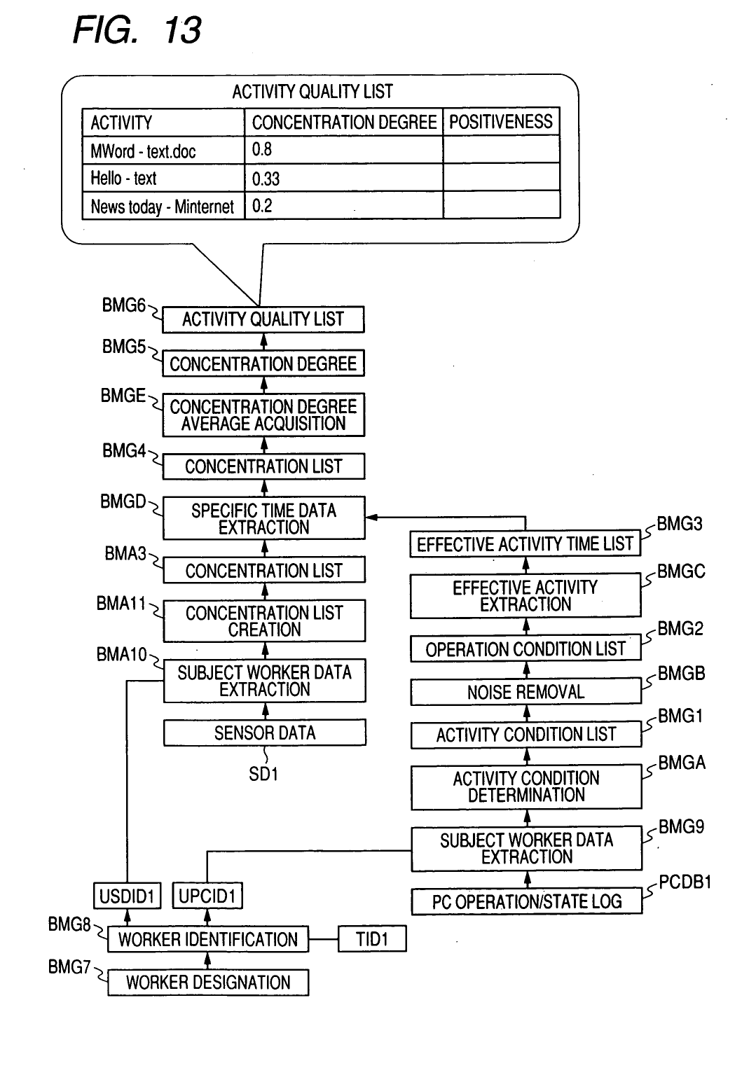

Activity quality calculation program PP1 extracts the effective activity and produces an activity quality list BMG6 through a method shown in FIG. 13.

An activity quality visualization program PV1 displays values of the concentration, the activeness, the face-to-face, the positiveness, the statement, the cohesion, and the betweenness in each of the PC activity or each of resultantly created files.

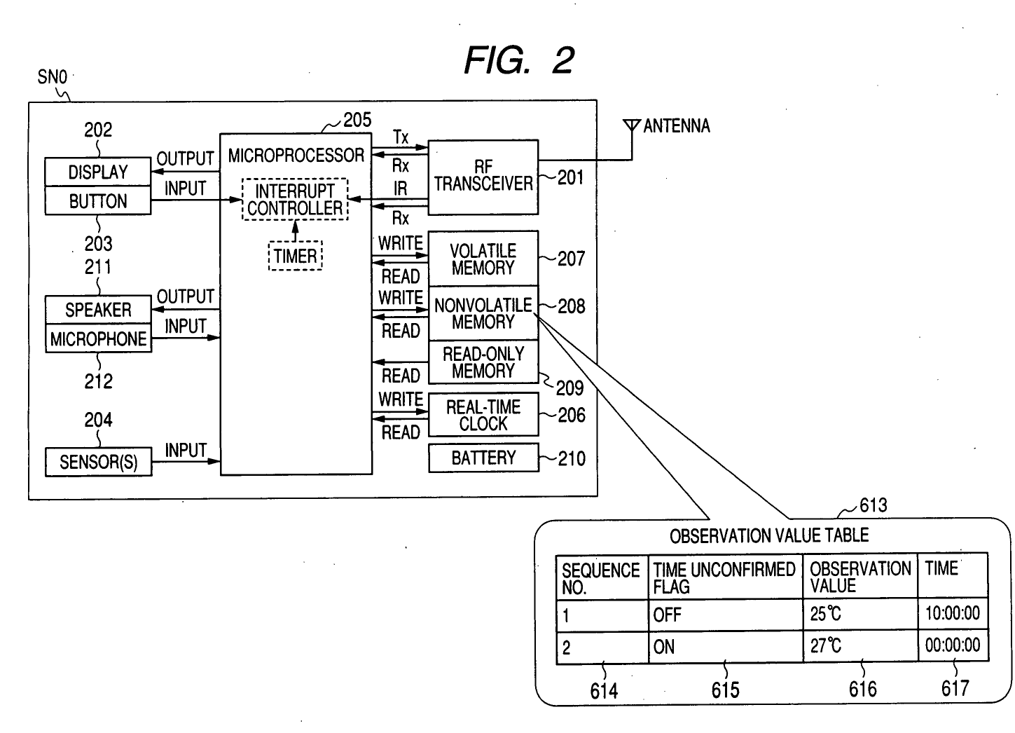

FIG. 2 is a diagram showing a specific example of a hardware configuration of the sensor node SN0 used in a sensor net system shown in FIG. 1 in more detail.

The sensor node SN0 includes a radio frequency transceiver 201 that conducts transmission and reception wirelessly, a display 202, a button 203, a sensor(s) 204, a microprocessor 205 that is a processor, a real-time clock 206 having an absolute time, a volatile memory 207, a nonvolatile memory 208, and a read-only memory 209 which are a storage unit, a battery 210 that supplies an electric power to the respective portions of the node, a speaker 211, and a microphone 212.

The sensor node SN0 rests the microprocessor, the radio frequency circuit, or the like in the hardware in a low power mode. The sensor node SN0 separately uses two operations consisting of a rest state and a start state where power supplies for all of the circuits turn on in every given cycle. The sensor node SN0 executes sensing by the aid of diverse sensors 204 in the start state. The sensed information is stored in a packet together with a time information of the real-time clock 206 by the microprocessor 205. The stored information is then sent to the base station and the relay terminal through an antenna from the RF transceiver 201 wirelessly, and also stored in an observation value table 613 of the nonvolatile memory 208. The observation value table 613 stores data therein in case wireless transmission would fail, and stores a sequence number 614 that is a sequence number of the observation value, a time unspecified flag 615 that stores whether the observation value has been set in time, or not, an observation value 616, and a time 617 of the observation value therein.

An operation button 203 is an input device that accepts the operation of a user, and enables the specific operation of the sensor node SN0 to start, or an operation parameter to be set by a specific button operation.

The display 202 is an output device for displaying information for the user. For example, when the sensor node SNO is located in a room or out of the room for environment measurement, the display 202 is capable of displaying the latest measurement value measured by the sensors 204. In this situation, in order to save the electric power, application that the display 202 usually displays nothing and displays the latest measurement value only when the specific button operation is conducted is preferable. Also, when the sensor node SN0 is a portable sensor node of a name tag type or a wristwatch type, application that the display 202 normally displays time information, the display 202 displays the message when a text message is received from the management server SV1, and the display 202 displays reception information when the sound message is received is preferable. Also, the display 202 is capable of displaying a stratified operation menu in association with the button operation of the user. The button operation is conducted according to the operation menu, thereby enabling an application user or a system manager to set the operation parameter of the sensor node or confirm error information at the time of communication failure.

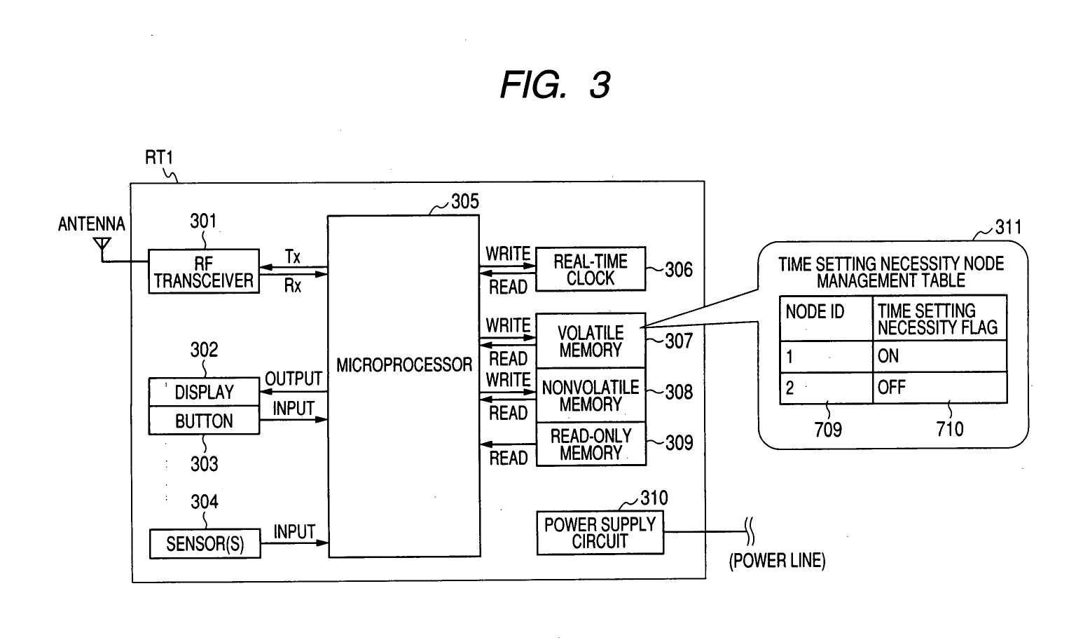

FIG. 3 is a diagram showing one specific example of the hardware configuration of the relay terminal RT1 in the sensor net system shown in FIG. 1. The relay terminal includes a RF transceiver 301 that conducts radio transmission and reception, a display 302, a button 303, a sensor(s) 304, a microprocessor 305, a real-time clock 306 having an absolute time, a volatile memory 307, a nonvolatile memory 308, and a read-only memory 309.

The relay terminal uses a time setting management table 311 stored in the volatile memory 307 for the purpose of command transmission to the sensor node and the time synchronization. The relay terminal receives a command to the sensor node which has been distributed from the base station wirelessly by the RF transceiver 301, and distributes the command to the sensor node that exists in the table 311 wirelessly. Also, the relay terminal receives sensing information sent from the sensor node wirelessly, and transmits the received sensing information to the base station wirelessly. In the time setting node management table 311 are stored a sensor node ID709 allocated in each of the sensor nodes, separately, and a time setting flag 710 for determining whether the sensor node of the node ID709 has been set in time, or not.

The relay terminal RT1 is located between the sensor node and the base station, thereby enabling a communication distance between the sensor node and the base station to be extended. However, in order to receive data from the sensor node or the base station, the data being not known when to be sent, the relay terminal RT1 must always wait for data. For that reason, it is desirable that the relay terminal RT1 operates by not a battery but external power feed unlike the sensor node. An electric power supplied from a power line is rectified by a power supply circuit 310, and then applied to the respective function units. Because a worry about the power consumption is unnecessary, it is unnecessary that the microprocessor 305 in the relay terminal RT1 comes into the rest state as in the case of the sensor node SN0. For that reason, although an interrupt control unit (interrupt controller or timer) is omitted in the figure, those functions are utilized within a general data transmission/reception algorithm.

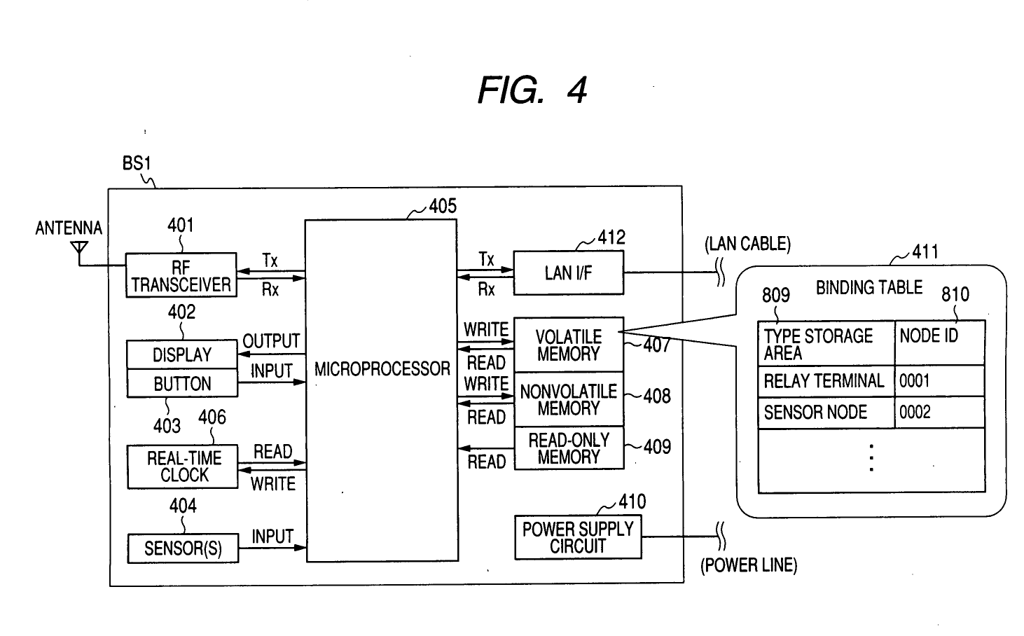

FIG. 4 is a diagram showing one specific example of the hardware configuration of the base station BS1 in the sensor net system shown in FIG. 1.

The base station is identical in configuration with the relay terminal RT1 except for the provision of the LAN communication interface (LAN I/F) 412 for communicating with the management server SV1 on the IP network, and therefore its description will be omitted. In the drawing, numbers 401 to 410 correspond to numbers 301 to 310 in FIG. 3. In the volatile memory 407 is stored a binding table 411 required to gasp and manage a device that is now running and the type of that device. In the binding table 411 are stored a type storage area 809 that stores whether the registered node is a relay terminal or a sensor node, and a node ID810 given to each of the nodes, individually.

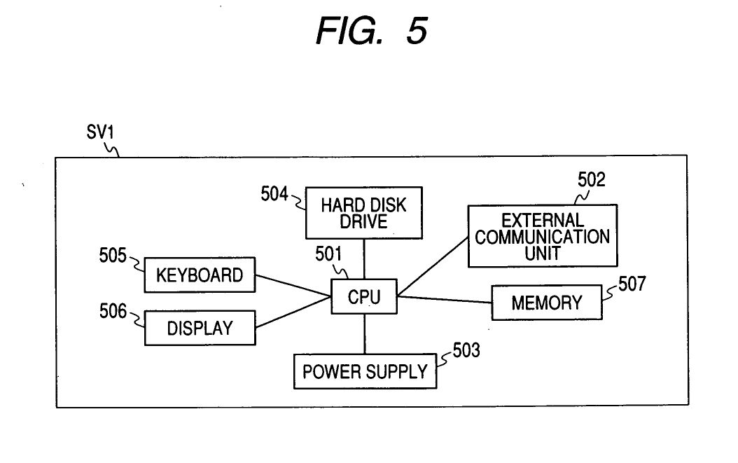

FIG. 5 is a block diagram showing one specific example of the hardware configuration of the management server SV1 in the sensor net system shown in FIG. 1.

The sensor net management server SV1 includes a CPU 501, an external communication unit 502, a power supply 503, a hard disk drive 504, a keyboard 505 that is an input device for giving a command from the user, a display 506 that is a display device, and a memory 507.

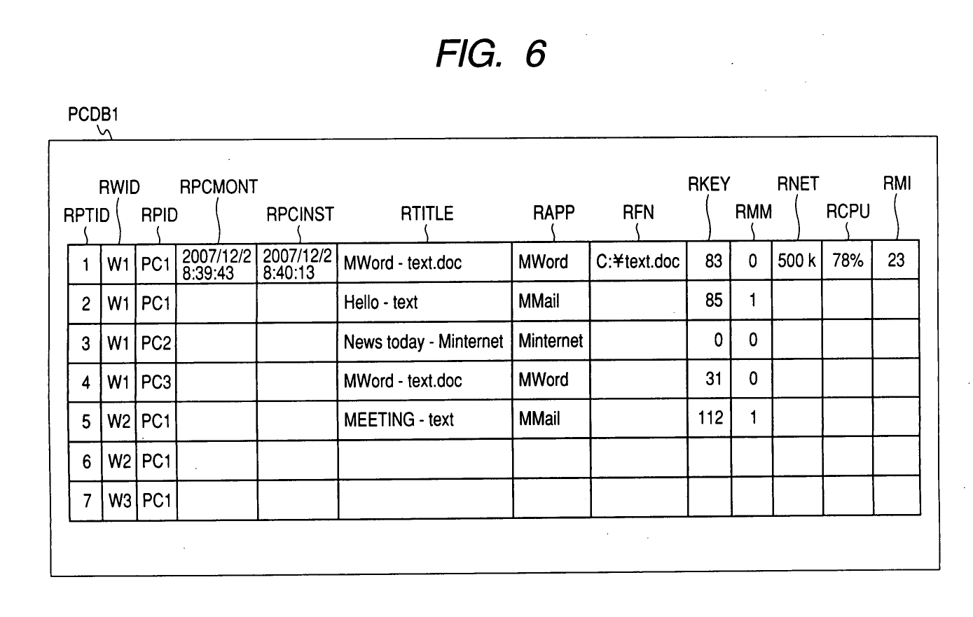

The sensor net management server SV1 receives data that passes through the external communication unit 502 and is collected from the sensor node 1 through the relay terminal RT1 by the base station 1, and transmits a command to the base station 1. Also, the sensor net management server SV1 receives activity information on the PC of the worker which has been acquired by the PC state/state monitoring program. The CPU 501 reads program such as middleware stored in the memory 507, processes data such as the observation value acquired through the external communication unit 502 according to a command of the program; stores data in the hard disk drive 504, or displays the data on the display 506. A specific example of processing and display which are executed by the management server SV1 will be described in detail later. Also, the CPU 501 analyzes a user command input from the keyboard 505, and distributes the user command to the base station 1 through the external communication unit 502. FIG. 6 is a diagram showing an example of the configuration and data of the table PCDB1 which is stored in the server SV1. In the table PCDB1, the activity information, the identification information of the worker, and the identification information of the PC are managed in association with each other. In this example, the activity information is diverse data acquired from the PC which is operated by the worker.

In a column RPTID is stored an ID specified to data for identifying the data.

In a column RWID is stored an ID for identifying the worker. When plural workers use the same PC, the ID can be substituted with an ID input to the user after login, or an ID when login.

In a column RPID is stored an ID for identifying the hardware of the computer used by the user in case one user would use plural PCs. The ID can be designated by the user, individually, when program starts, or can be substituted with a host name of the computer or a MAC address that is identifier of the network.

In a column RPCMONT is stored a time when the data at the subject row is acquired by the PC operation/state monitoring program MON1.

In a column RPCINST is stored a time when the data at the subject row is stored in the table PCDB1.

In a column RTITLE is stored a title character string of a window operated on the PC by the worker at the subject time.

In a column RAPP is stored a character string of the name of the application operated on the PC by the worker at the subject time.

In a column RFN is stored a character string of the name of the file operated on the PC by the worker at the subject time.

In a column RKEY is stored the number of times of hitting the keys of the keyboard KE1 by the worker during a constant time until the subject time. The constant time can be a fixed value such as 10 seconds till the subject time, or can be a time from a time obtained by the previous PC operation/state monitoring program MON1 to the subject time.

In a column RMM is stored the distance by which the mouse of the PC travels by the worker during the same constant period of time till the subject time. The travel distance of the mouse is calculated on the basis of the number of pixels by which the mouse cursor moves on the PC screen.

In a column RNET is stored the volume of data which has been transmitted or received on the network during the same given period of time till the subject time. The data is transmitted or received mainly when a mail is transmitted or received, when an internet is browsed, or when a shared database is accessed.

In a column RCPU is stored an operating rate of the CPU in the PC during the same constant period of time till the subject time.

In a column RMI is stored the number of unread EMAIL during the same constant period of time till the subject time.

The correspondence relationship of the activity information, the identification information of the worker, and the identification information of the PC operated by the worker is recorded as described above. As a result, even if the same worker uses plural PCs, or plural workers use the same PC, the activity information of the respective workers can be correctly managed. Also, the determination of the activity condition or the creation of the activity condition list which will be described later can be executed by referring to the activity information of the respective workers.

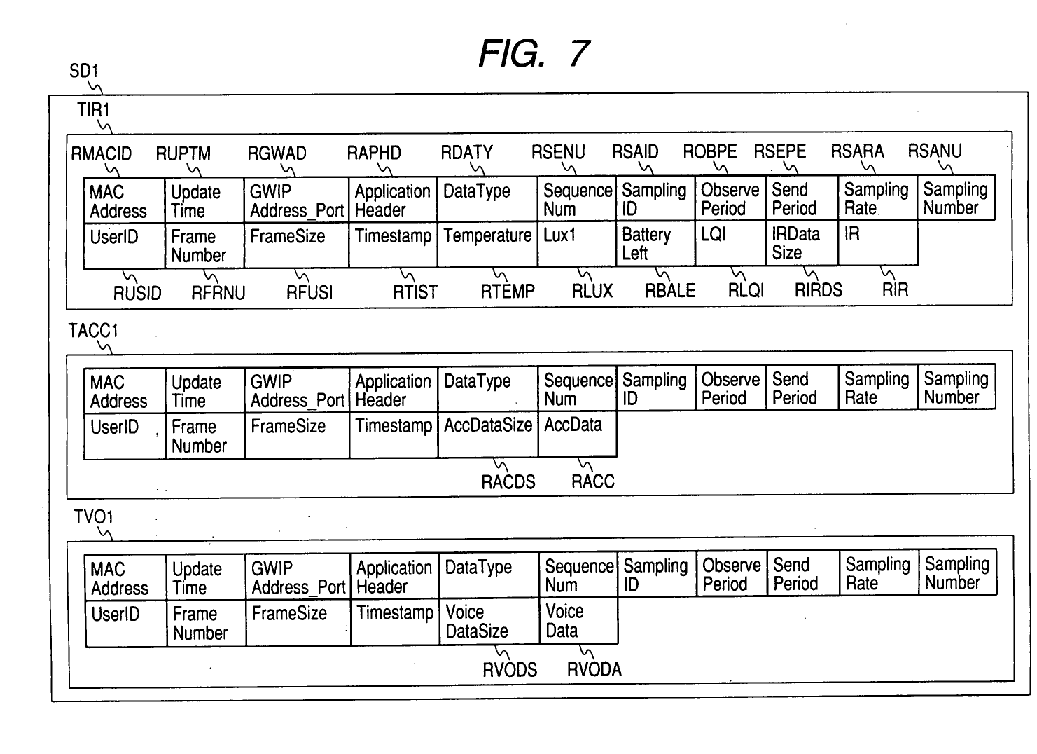

FIG. 7 is a diagram showing an example of the configuration and data of the database SD1 of the sensor data stored in the management server SV1. In the database SD1, the sensor data, the identification information of the sensor device used by the worker, and the identification information of the worker are associated with each other and managed.

A table TIR is a table in which temperature data, illuminance data, and the detection data of infrared rays are associated with each other and stored.

In a column RMACID is stored a network address of the device.

In a column RUPTM is recorded a time at which data is stored in the table SD1.

In a column RGWAD is stored an identifier of a base station device (for example, BS1) that receives data wirelessly.

In a column RAPHD is stored the sort of sensor device. For example, 1 is stored in the bracelet type device, and 2 is stored in the name tag type device.

In a RDATY is stored the sort of data stored in the wireless packet. For example, 1 is stored in data stored as a set of temperature data, illuminance data, and the detection data of infrared rays, 2 is stored in acceleration data, and 3 is stored in sound data. A column RSENU is a cyclic counter that assigns 0000 to FFFF in the transmission order of the frame by the sensor device, and resets the number subsequent to FFFF to 0000. When divided frames are joined together, the cyclic counter stores a sequent number of the first frame therein.

In a column RSAID, the same sampling identifier is assigned to a divided frame including data sampled in the same sensing cycle.

In a column ROBPE is stored the present sensing interval of the sensor device.

In a column RSEPE is stored the present wireless transmission interval of the sensor device. The wireless transmission interval can be a numeric value representative of an interval, or can be a value representative of a multiple number of the sensing interval.

In a column RSARA is stored an acquisition cycle of the sensor data in the sensor device.

In a column RSANU is stored the number of present samplings of the node.

In a column RUSID is stored an identification ID of a user who uses this device.

In a column RFRNU, when a frame is divided into plural pieces, n-divided frames in total are numbered in the down order of n, n−1, n−2, . . . , 3.2.1. The number 1 is a final divided frame. The number 0 represents a 256-th frame.

In a column RFRSI is stored the total number of successive frames which are transmitted in division.

In a column RTISI is stored a time of the sensor device when this data is acquired by the sensor.

In a column RTEMP is stored temperature data acquired by the sensor device.

In a column RLUX is stored illuminance data acquired by the sensor device.

In a column RBALE is stored a value indicative of a battery power of the sensor device, for example, a supply voltage.

In a column RLQI is stored a value indicative of the wireless communication quality between the sensor device and the base station, for example, an LQI (link quality indicator).

In a column RIRDS is stored the number of detection of infrared data that is stored in this data.

In a column RIR is stored infrared data acquired by the sensor device.

A table TACC1 stores data of an acceleration sensor instead of data such as infrared rays of the table TIR. The table TACC1 stores the same contents as those of the table TIR1 between a column RMACID and a column RTIST.

In a column RACDS is stored the number of detection of acceleration data stored in this data.

In a column RACC is stored acceleration data acquired by the sensor device.

A table TVO1 stores sound data instead of data such as infrared rays of the table TIR. The table TVO1 stores the same contents as those of the table TIR1 between the column RMACID and the column RTIST.

In a column RVODS is stored the number of detection of sound data stored in this data.

In a column RVODA is stored sound data acquired by the sensor device.

As described above, the correspondence relationship of the sensor data, the identification information of the sensor device, the identification information of the worker, and so on are recorded. As a result, even when the respective workers use plural sensor devices, the sensor data acquired by the sensor devices of the respective workers can be correctly managed. Also, an action index indicative of the action state of the worker which will be described later is calculated by referring to the sensor database SD1, thereby making it possible to produce the respective tables stored in the quality database SD2.

FIG. 8 is a diagram showing an example of a worker identification information storage table TID1 that stores identification information for associating the sensor data obtained from the sensor node SN0, and identification information for associating log data acquired from the PC operation/state monitoring program MON1 with each other.

In a sensor identifier management table TSDID are recorded an attribute such as IDs or sorts of the respective sensor devices in association with the users.

In a column RUID is recorded an ID specific to the subject user.

In a column RSDID is recorded an ID specific to the subject sensor device.

In a column RSDTYPE is recorded a value representative of the sort of subject sensor device. For example, the value is 1 in the case of the name tab type device, 2 in the case of the wristwatch type device, and 3 in the case of a charger type device that is placed on a desk.

In a PC identification management table TPCID is recorded an attribute such as the IDs or the sorts of the respective PCs in association with the users.

In a column RUID is recorded an ID specific to the subject user.

In a column RPCID is stored an ID specific to the subject PC device. For example, a host name of the PC is stored in the column RPCID.

In a column RNET is stored a network MAC address as an ID specific to the subject PC device. When discrimination is disenabled by the host name due to a difference in OS, the network MAC address is used as substitute information or used for the purpose of preventing illicitness such as impersonation.

In a user profile management table TUP is stored information such as a residence or contact information of the user.

In a column RUID is recorded an ID specific to the subject user.

In a column RUNAME is recorded the name of the subject user. In a situation where storage of individual information is difficult, nickname is substituted for the individual information, or management may be conducted by only number.

In a column RPHONE is stored a telephone number used by the subject user.

In a column RMAIL is stored an e-mail address used by the subject user.

In a column RROOM is stored a room used by the subject user.

In a column RLOGINID is stored a login ID when the subject user starts the PC operation/state monitoring program MON1. A login authentication is necessary when plural persons use the same PC. The login ID can be substituted with an ID specific to the user which is stored in the column RUID.

In a column RPASSWD is stored a password when the subject user starts the PC operation/state monitoring program MON1.

As described above, the sensor net system according to this embodiment manages the IDs of the respective users by the aid of an ID table that stores the identifiers. In the ID table are stored the ID of the sensor device used by the user and the ID of the PC used by the user, and recorded a correspondence correlation therebetween. The ID of the sensor device is acquired by being automatically transmitted from the sensor node. The ID of the PC is acquired by prompting the user to input the ID and the corresponding password when using the PC. As a result, it is possible to produce an activity quality list that associates the respective activities with the activity quality information as will be described below.

Subsequently, a description will be given of the operation of synchronizing a time of the entire system by using the configurations and functions of the respective devices.

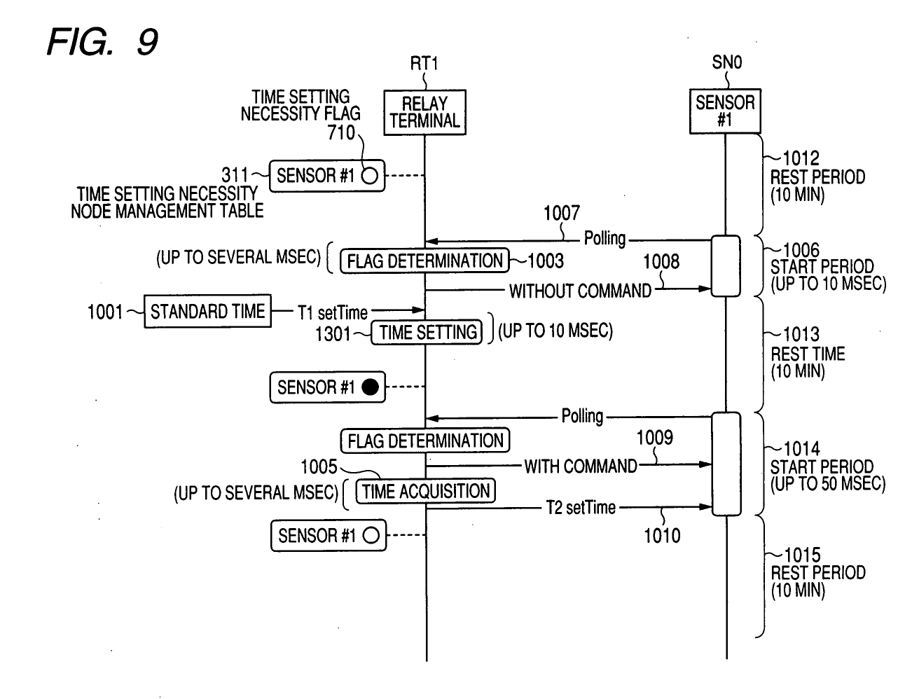

In this embodiment, in the case of setting times of clocks equipped in the base station, the relay terminal, and the sensor node, the relay terminal acquires the latest time of the relay terminal at a time when the relay terminal is required to transmit a command by the sensor node. Then, the relay terminal issues a time setting command to set a time of the sensor node that issues the command transmission request. Hereinafter, the operation will be described with reference to FIG. 9.

FIG. 9 is a time setting sequence diagram of the relay terminal RT1 and the sensor node SN0 (sensor #1) when the sensor node SN0 (sensor #1) conducts the intermittent operation having a cycle of 10 minutes. FIG. 9 is a diagram showing the time setting sequence, and therefore the operation other than time seating such as observation is omitted.

When the sensor #1 returns from a rest period 1012, and enters a start period 1006, the sensor #1 conducts a polling 1007 on a host relay terminal RT1. At that time, the relay terminal RT1 does not receive a time set request “set Time”, and a time setting necessity flag 710 within the time setting request node management table 311 is off (white indication in the figure) (1003). Therefore, the relay terminal transmits a signal with no command 1008 in response to the polling 1007 to the sensor #1. The sensor #1 that has received the response shifts to a rest period 1013 immediately. In this situation, a length of the start period 1006 is about several ms to about several tens of ms including the polling and the reception of a response.

Thereafter, when the relay terminal RT1 acquires a reference time 1001 issued by the management server SV1, the relay terminal RT1 sets or corrects the real-time clock 306 of the relay terminal per se (1301), and turns on (gray indication in the figure) the time setting necessity flag 710 of the sensor node SN0 that is under control of the relay terminal RT1, and registered in the time setting request node management table 311. When receiving the polling 1007 that is a command request from the sensor node (sensor #1) chat is under control of the relay terminal RT1, and registered it he time setting request node management table 311, the relay terminal RT1 confirms the time setting necessity flag 710. Then, the relay terminal RT1 returns to a signal with a command 1009 when the flag is on, acquires a time by the real-time clock 306 of the relay terminal per se (1005), and distributes a time (T2) acquired as the setTime command 1010 to the sensor #1. Thereafter, the relay terminal 3 turns off the time setting necessity flag 710 of the sensor node. Upon receiving a return of the signal with a command 1009, the sensor #1 maintains a reception waiting state for a little, and corrects the time of the real-time clock 206 of the sensor node per se, and shifts to a rest period 1015. In this situation, a start period 1014 of the sensor #1 is longer than the start period 1006 because the “set Time” command is received, and time setting is conducted during the start period 1014, but about 10 ms to about 50 ms in total which is instant as compared with 10 minutes being a length of the rest period.

As described above, the use of the time synchronizing method specific to the intermittent operation of the sensor node enables the times of the relay terminal and the sensor node to be synchronized with each other while a reduction in the power consumption of the sensor node is maintained.

Also, the sensor net system according to this embodiment has a time setting necessity flag corresponding to each of all the sensor nodes under control of the relay terminal. Then, upon receiving the time setting command from the base station, the relay terminal turns on the time setting necessity flag at a time when the clock time of the relay terminal is set. When the relay terminal receives the command transmission request from the sensor node, the relay terminal confirms the state of the time setting flag, and transmits the time setting command only when the flag is on. Then, the relay terminal turns off the time setting flag at a time when receiving a return of the time setting command, thereby setting the time of all the sensor nodes.

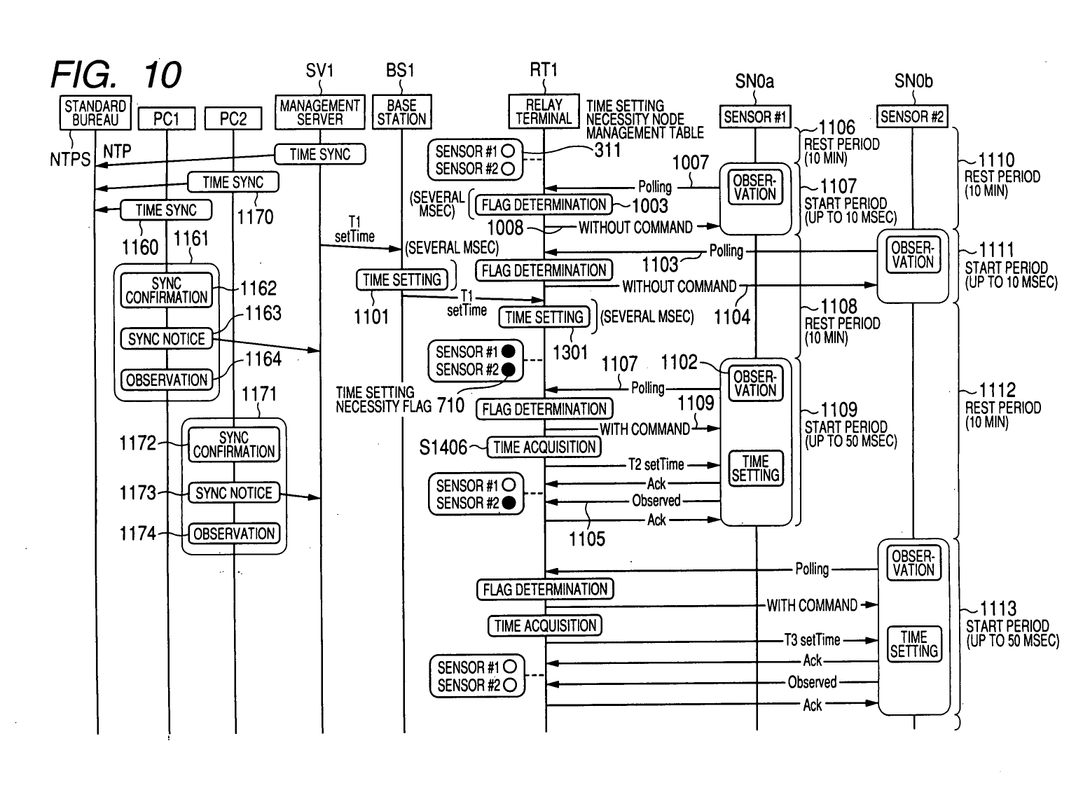

Also, in the sensor net system according to this embodiment, the time synchronization with the PC is executed according to the above time synchronization. Each of the PCs is synchronized with a Time Standard Bureau by an NTP (network time protocol). The PC operation/state monitoring program that records the operation on the PC confirms whether time synchronization could be executed, or not, when the program starts, and starts observation after the confirmation result is notified the management server SV1 of. When the synchronization of the time could not be confirmed at the time of start, the confirmation of synchronization and the process of notification are periodically executed after the observation starts. With the above operation, it is confirmed that the PC is synchronized. Hereinafter, the operation will be given with reference to FIG. 10.

FIG. 10 is a time setting sequence diagram of the management server SV1, the base station 1, the relay terminal RT1, two sensor nodes SN0a and sN0b, and two PC devices, PC1 and PC2. When the number of sensor nodes SN0 and the number of PC devices are three or more, the same sequence is applied.

First, when the sensor #1 returns from a rest period 1016, and enters a start period 1107, the sensor #1 conducts the polling 1007 on the host relay terminal RT1. At that time, the relay terminal RT1 does not receive the “set Time”, and request “set Time”, and all of time setting necessity flags 710 within the time setting request node management table 311 are off (1003). Therefore, the relay terminal RT1 transmits the signal with no command 1008 in response to the polling 1007 to the sensor #1. The sensor #1 that has received the response shifts to a rest period 1108 immediately. In this situation, a length of the start period 1107 is about several ms to about several tens ms including the polling and the reception of a response. Likewise, when the sensor #2 enters a start period 1111 after return, the sensor #2 conducts a polling 1103 on the host relay terminal RT1. The relay terminal returns a signal with no command 1104 like the sensor #1, and the sensor #2 that has received the return shifts to the rest period 1112 immediately.

The management server SV1 synchronizes the time of the Standard Bureau NTPS by an NTP (network time protocol). The management server transmits a time (T1) as the setTime command c the base station BS1 periodically or at a time designated by the user. The base station BS1 sets or corrects the real-time clock 406 by using the received time (T1) (1101). The base station 3 confirms “Binding Table” which is a node management table with which the base station is capable of communicating simultaneously when executing the real-time clock setting 1101. Then, the base station 3 transmits the time (T1) acquired from the management server SV1 as the “set Time” command to the relay terminal that is under control of the base station 3 and registered in the table. Although only one relay terminal RT1 is shown in FIG. 10, when there are plural relay terminals registered in the table, the base station 3 transmits the time (T1) to all of the relay terminals in the same manner to execute the time synchronization.

The Standard Bureau NTPS is a server that manages the present time, which is a precise time source such as a GPS, standard wave, or an atomic clock, or a server connected to the time source. The server can be managed by this system, or can be substituted with a public server.

The relay terminal RT1 sets or corrects the real-time clock 306 on the basis of the time (T1) received from the base station, and turns on the time setting necessity flag 710 with respect to all of the sensor nodes that are under control the relay terminal RT1 and registered in the time setting necessity node management table 311. The sensor node SN0a (sensor #1) conducts observation (1102) immediately after return from the rest period 1108, and then conducts the polling 1107 that is a command request on the host relay terminal. When the host relay terminal RT1 of the sensor #1 receives the rolling 1107 that is a command request from the sensor node that is under control of the host relay terminal RT1 and registered in the time setting necessity node management table 311, the host relay terminal RT1 confirms the time setting necessity flag 710 of the sensor node. When the flag is on, the host relay terminal RT1 returns the signal with a command 1009, acquires a time (1406) from the real-time clock 306 of the relay terminal RT1 per se, and transmits a time (T2) as the “setTime” command. Thereafter, upon receiving Ack that is a “set Time” command response from the sensor #1, the host relay terminal RT1 turns off the time setting necessity flag 710 of the sensor node. In this situation, the start period 1109 of the sensor #1 is longer than the start period 1107 because the “set Time” command is received and the time setting is conducted during the start period 1109. However, the start period 1109 of the sensor #1 is about 10 ms to about 50 ms in total of the processing time during which the polling, the time setting reception, the observed event transmission (1105), and the reception of return (Ack) are executed, which is instant as compared with 10 minutes being a length of the rest period.

When the sensor node SN0a (sensor #1) receives a return of the signal with a command 1009, the sensor node SN0a maintains the reception waiting state for a while, and corrects the time of the real-time clock 206 of the sensor node per se on the basis of the received time (T2). The sensor #1 acquires a time from the real-time clock 206 of the sensor node per se, assigns the time to the observation value, and transmits the observation value to the relay terminal RT1 as the observed event (1105). The same sequence as the time setting sequence of the sensor #1 is applied to the sensor node SN0b (sensor #2).

Although being not shown in FIG. 10, there is the possibility that plural sensor nodes SN0 are connected directly to the base station 1. In that case, a sequence between the base station 1 and the sensor node SN0 is a sequence in which the relay terminal RT1 is substituted with the base station 1 in the sequence between the relay terminal RT1 and the sensor node SN0. It is needless to say that the base station 1 and the sensor node SN0 take the same action, respectively.

Each of the PC devices PC1 and PC2 synchronizes (1160, 1170) the time with the Standard Bureau NTPS by the NTP, respectively. When the PC operation/state monitoring programs MON1 (1161) and MON2 (1171) starts, each of the PC devices PC1 and PC2 confirms whether the synchronization of time can be performed, or not (1162, 1172), and gives notice of the result to the management server SV1 (1163, 1173). Thereafter, each of the PC devices PC1 and PC2 performs an observation process (1164, 1174). Each of the PC devices PC1 and PC2 can periodically conduct the confirmation of synchronization and the notice process after the observation starts in case the synchronization of time could not be confirmed at the time of start.

As described above, the time synchronization of the PC is executed in parallel with the time synchronization of the relay terminal and the sensor node, thereby enabling the log data of the PC and the sensor data to be associated with each other on the basis of the time information.

Subsequently, a description will be given of a method of calculating the action index indicative of a physical action state of the worker as information related to the quality of the activity according to data acquired from the sensor device. In this example, the action state includes an action of the worker who does not operate the PC, which cannot be estimated from the PC operation of the worker. For example, the action state includes the activity degree, of the degree of concentration of a human, the number of persons whom the worker faces until the worker produces a certain document, or the positiveness of the communication at that time. Also, the action index is a value indicative of the action state, and for example, the degree of concentration 1 is indicative of a state where the worker concentrates, and the degree of concentration 0 is indicative of a state where the worker does not concentrate.

Hereinafter, a description will be given of a method of obtaining the degree of concentration, a face-to-face time, the positiveness in the face-to-face, the cohesion with members of a team, and the centricity of the communication in an organization. First, the degree of concentration of the worker is obtained in the respective time zones. It is found from the results of video observation or the like that a time band during which the worker concentrates on the activity is lower in the frequency of acceleration than a time band during which the worker does not concentrate on the activity. For example, when the worker conducts conversation, the frequency component of 2 Hz to 3 Hz is increased. Under the circumstances, in this example, it is assumed that a time band during which the frequency of acceleration is lower than a given threshold value is a state where the worker concentrates on the activity. Typically, the frequency of acceleration is 2 Hz or lower. It is needless to say that because this value is different according to the person and the type of business, the value can be changed according to the situation.

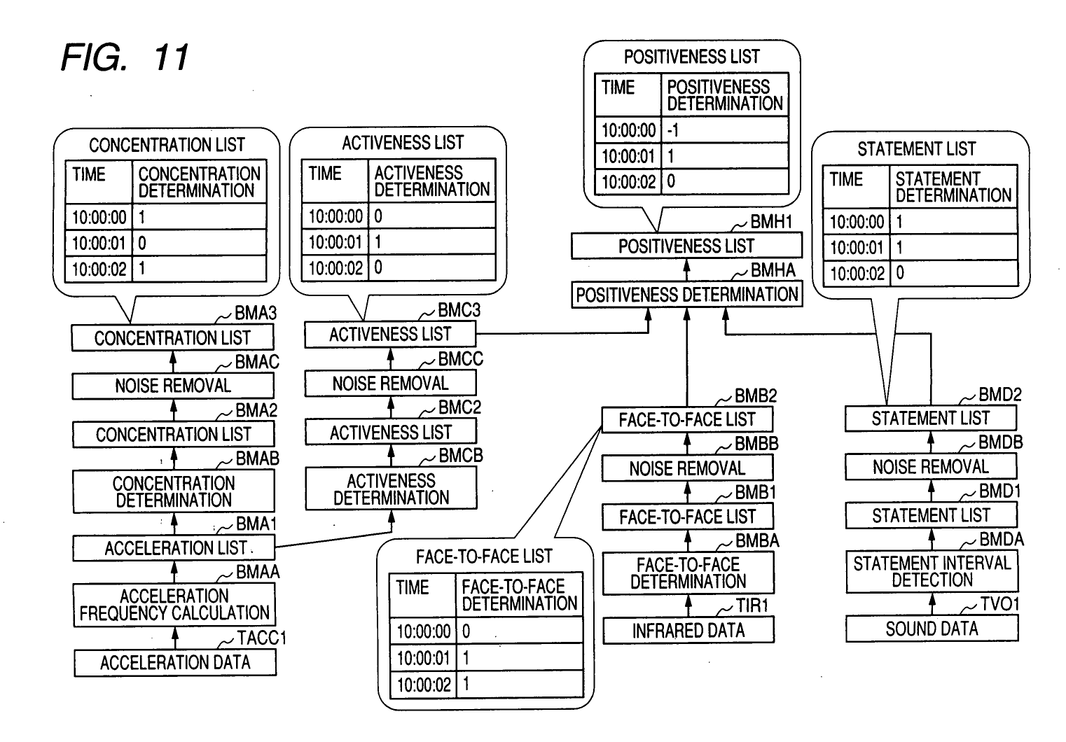

In order to calculate the degree of concentration, the following acceleration frequency calculation (BMAA), the concentration determination (BMAB), and the noise removal (BMAC) are conducted in a procedure shown in FIG. 11.

The acceleration frequency calculation (BMAA) is a process for obtaining a frequency from the acceleration data (TACC1) which is arranged in time series. The frequency is defined as a vibration frequency of waves for one second, that is, an index indicative of the intensity of vibrations. The frequency may be steadily calculated by Fourier transform, however, in this applied example, for simplification of calculation, a zero cross value is used in correspondence with the frequency. As a result, the processing load of the server is reduced, and this example is effective to an increase in the calculation amount of the server which is attributable to an increase in the number of sensor nodes.

The zero cross value is obtained by counting up the number of times by which the value of time series data within a given period becomes zero, and more precisely the number of times by which the time series data changes from a positive value to a negative value, or from a negative value to a positive value. For example, when it is assumed that a period during which a value of acceleration changes from positive to negative, and the value then again changes from positive to negative is one cycle, the vibration frequency per one second can be calculated according to the number of counted zero crosses. The vibration frequency per one second which has been thus calculated can be used as an approximate frequency of acceleration.

Further, because the sensor node SN0 of this applied example has an acceleration sensor of three axial directions, zero cross values in the three axial directions in the same period are added to calculate one zero cross value. As a result, in particular, fine pendular motions in the lateral direction and the forward and back direction are detected and can be used as an index representative of the intensity of vibrations.

A larger value than an interval of successive data (that is, an original sensing interval) is set as “a constant period” during which the zero cross value is counted. For example, the zero cross value per second, or the zero cross value per minute is obtained.

As a result of the acceleration frequency calculation (BMAA), the zero cross value in each time and the vibration frequency of second unit which has been calculated according to the zero cross value are generated on a memory as an acceleration list (BMA1), or as a file.

Subsequently, the concentration determination (BMAB) is implemented on the list (BMA1). As described above, whether concentration is made, or not, is determined on the basis of whether the acceleration is lower than a given threshold value, or not. The list (BMA1) is sequentially scanned, and “1” is inserted into a row where the vibration frequency falls below the threshold value as a concentrated state, and “0” is inserted into a row where the vibration frequency exceeds the threshold value as a deconcentrated state. As a result, the concentration list (BMA2) obtaining whether concentration is conducted in the respective time zones, or not, by second unit is generated.

In this example, there is the possibility that the vibration frequency is equal to or lower than the threshold value at a certain momentary time, but the vibration frequency is equal to or higher than the threshold value around the momentary time, and concentration is not made. Conversely, there is the possibility that the vibration frequency is equal to or higher than the threshold value at a certain momentary time, but the vibration frequency is equal to or lower than the threshold value around the certain momentary time, and concentration is made. A mechanism for removing the above momentary noise is required.

Under the above circumstances, the noise removal (BMAC) is implemented on the subject list (BMA2). The role of the noise removal is to generate a series such as “0000000111111111111” which is obtained by removing a momentary change from a time series change of the concentration degree obtained above, for example, a series such as “0001000111111001111” taking the time series around the moment into consideration. The above noise removing process is executed, thereby enabling the degree of concentration to be calculated taking time zones around the momentary time into consideration. As a result, it is possible to grasp the concentration reflecting the more real condition. The same is applied to the effect of the noise removal process such as a face-to-face determination which will be described below.

The process for removing the noises can be also performed by removing the radio frequency component through a low pass filter. In the following description, a majority method will be described as a simpler method. In this method, the time zones are determined in the order of time series from first to last one by one. It is assumed that an i-th time zone is now to be determined. In this example, in the time bands of (2n+1) in total from an (i-n)th time zone to an (i+n)th time zone, the number of concentrations and the number of deconcentrations are counted up. In this situation, when the number of concentrations is larger, and concentration is not made in the i-th time zone, a state of the i-th time zone is changed into a state where concentration is made. Conversely, when the number of deconcentration is larger, a state of the i-th time zone is changed into a state where deconcentration is made. For example, when the above method is applied to a series such as “0001000111111001111” with n=2, a series of “0000000111111111111” is generated. When n is smaller, noises reflecting only a short period of time around n are removed, and when n is larger, noises reflecting a long period of time are removed. The degree of n depends or the person and the sort of business. For example, it is possible that after fine noises have been first removed by small n, slightly longer noises are again removed by larger n. The majority method is thus executed, thereby making it possible to reduce the calculation amount of the server and to reduce the processing load.

As a result, a concentration list (BMA3) indicative of whether concentration is made in the respective time zones, or not, by second unit is generated.

Subsequently, a description will be given of a step of obtaining a face-to-face time. Whether a certain worker faces a person in a certain time zone, or not, can be determined by whether a sensor device worn by the worker detects the infrared data of another sensor device, or not in the subject time zone. Similarly, in this case, because there is the possibility that the erroneous determination is made when only a certain moment is viewed as in the above concentration degree determination, it is necessary to remove the noises while the time zones around the moment are viewed. Accordingly, determination is made by the following face-to-face determination (BMBA) and the noise removal (BMSS). FIG. 11 shows a flow of the determination.

In the face-to-face determination (BMBA), whether the present subject worker faces another worker at the respective times, or not, is obtained by a given time unit (for example, second unit). Simply, whether detection data in a certain time zone exists, or not, is checked in the order from the infrared database (TIR1), and “1” is set to a determination value when the subject worker faces another worker, and “0” is set to the determination value when the former does not face the latter. As a result of the face-to-face determination (BMBA), the face-to-face list (BMB1) indicative of whether face-to-face is made in the respective times, or not, in a given time unit (for example, second unit) is generated on a memory, or as a file.

Subsequently, a noise removal (BMBB) is implemented on the list (BMB1). The role of the noise removal is to generate a series such as “0000000111111111111” which is obtained by removing a momentary change from a time series change of the face-to-face, for example, a series such as “0001000111111001101” taking the time zones around the moment into consideration, as with the noise removal (BMAC) in the above concentration degree calculation. The same method as that of the noise removal (BMAC) is applicable.

As a result, a face-to-face list (BMB2) indicative of whether face-to-face is made in the respective times, or not, by a given time unit (for example, second unit) is generated.

Subsequently, a step of obtaining the positiveness in the face-to-face conference will be described. When a worker is positive in the face-to-face conference, the positiveness appears in the action such that the travel distance of his body increases, or the quantity of speech increases. Under the circumstances, in this example, whether the worker is positive, or not, is determined from two aspects of whether a frequency of acceleration in the face-to-face situation exceeds a given threshold value, or not, and whether a statement is made in the face-to-face situation, or not.

In order to calculate the positiveness, the face-to-face determination and the noise removal, the acceleration frequency calculation, the activeness determination, and the noise removal, a statement interval detection, and a noise removal are executed as follows. FIG. 11 shows a flow thereof.

The face-to-face determination and the noise removal are identical in the process with the above-mentioned face-to-face determination (BMBA) and the noise removal (BMBB). The acceleration frequency calculation is conducted by the same process as that of the above acceleration frequency calculation (BMAA).

The subsequent activeness determination (BMCB) is a step of determining whether the acceleration exceeds a given threshold value, or not. For example, when frequency components of 2 Hz or higher which frequently occur during conversation frequently occur, it is determined that the worker is active in that time zone. More specifically, the list (BMA1) generated as a result of the acceleration frequency calculation (BMAA) is scanned in the order. Then, “1” is set to a determination value on a column where the vibration frequency exceeds the threshold value as an active state, and “0” is set to the determination value on a column where the vibration frequency falls below the threshold value as an inactive state. As a result, an active list (BMC2) indicative of whether the worker is active in the respective time zones, or not, by the second unit is generated.

The subsequent noise removal (BMCC) is identical in the processing with the above-mentioned noise removal (BMAC). As a result, an active list (BMC3) indicative of whether the worker is active in the respective time zones, or not, by the second unit is generated.

In the statement interval detection (BMDA), an interval during which a person speaks is specified according to a sound signal acquired by the sensor device. As a method of detecting the statement interval according to the sound signal, there can be used a manner using a sound power in a short period of time, or a manner using a phoneme recognition result.

The sensor device frequently conducts the intermittent operation with low power directivity as described above, and it is difficult to acquire the sound signals over all of the time zones. For that reason, the phoneme recognition can be only partially applied. Under the above circumstances, in this example, as a simple method, whether the statement is made, or not, is determined by whether the sound power for one second in the certain time zone exceeds a constant threshold value, or not. When the sound signal is operated in a time series, and the sound power in a given period exceeds the threshold value, “1” is set as the worker speaks, and when the sound power does not exceed the threshold value, “0” is set. As shown in FIG. 11, as a result of the statement interval detection (BMDA), a statement list (BMD1) indicative of whether the statement is made in the respective times, or not, by a given time unit (for example, second unit) is generated on a memory, or as a file.

A subsequent noise removal (BMDB) is identical in the processing with the above noise removal (BMAC). The momentary noise is detected from a change in the time series, and corrected. As a result, a statement list (BMD2) indicative of whether the statement is made in the respective times, or not, by a given time unit (for example, second unit) is generated.

Subsequently, the positiveness degree determination (BMHA) is executed by the aid of the generated face-to-face list, activeness list, and statement list to calculate a positiveness degree list (BMH1) at the respective times. As described above, the positiveness degree can be determined by whether the worker who faces another person is active or speaks, or not. Accordingly, for example, the face-to-face list, the activeness list, and the statement list are sequentially scanned in the time series. When the data of the face-to-face list is indicative of a face-to-face state, the data of the activeness list is indicative of an activity state, and the data of the statement list is indicative of a statement state in a certain same time zone, it is assumed that the worker is positive, and “1” is set to the determination value. Conversely, when the data of the activeness list is indicative of an inactivity state, and the data of the statement list is indicative of a non-statement state although the data of the face-to-face list is indicative of a face-to-face state, it is assumed that the worker is negative, and “0” is set to the determination value. When the data of the face-to-face list is indicative of a non-face-to-face state, “−1” is set to the determination value assuming that it is unnecessary to determine the positiveness degree.

Subsequently, a description will be given of a method of obtaining the cohesion with members of a team and the centricity of the communication in an organization. They are an index known as “cohesion” or “betweenness centrality” in social network analysis. A calculating method will be described in brief below.

The social network analysis constitutes a network graph that generally first expresses the respective persons as nodes, and a communication between two persons as a line between the nodes.

In the above network graph, when workers that communicate directly with a certain worker W0 are n of W1 to Wn in the number, “cohesion” expresses how much n workers communicate with each other. For example, when pairs of workers can be extracted from the n workers, calculation is conducted in such a manner that 1 is set if communications are made between all pairs of workers, and 0 is set if no communication is made between the pairs of workers at all. This is obtained by dividing the number of pairs who communicate with each other by the number n(n−1)/2 of available pairs.

The “betweenness centrality” is an index representative of how much a certain worker W0 communicates with all of m workers including workers not communicating directly with the worker W0, that is, how much the worker W0 has a hub-like element. For example, when all of available pairs of workers are extracted from the m workers, calculation is made in such a manner that “1” is set if the worker W0 mediates communications with all pairs of workers, and “0” is set if the worker W0 does not mediate a communication with any pair of workers at all. As an obtained procedure, two works Wi and Wj are first selected from the above network graph. Then, the shortest route connecting Wi and Wj is searched on the above network graph. Then, it is considered that all of k nodes on the shortest route communicate with Wi and Wj, and 1 is added to the betweenness centrality of the k nodes. When the number of shortest routes is not one but plural (m patterns), not 1 but 1/m is added to the betweenness centrality of the nodes on the respective routes. When the betweenness centrality is calculated with respect to all of i and j, that is, the available all pairs, the betweenness centrality of the respective nodes are finally obtained.

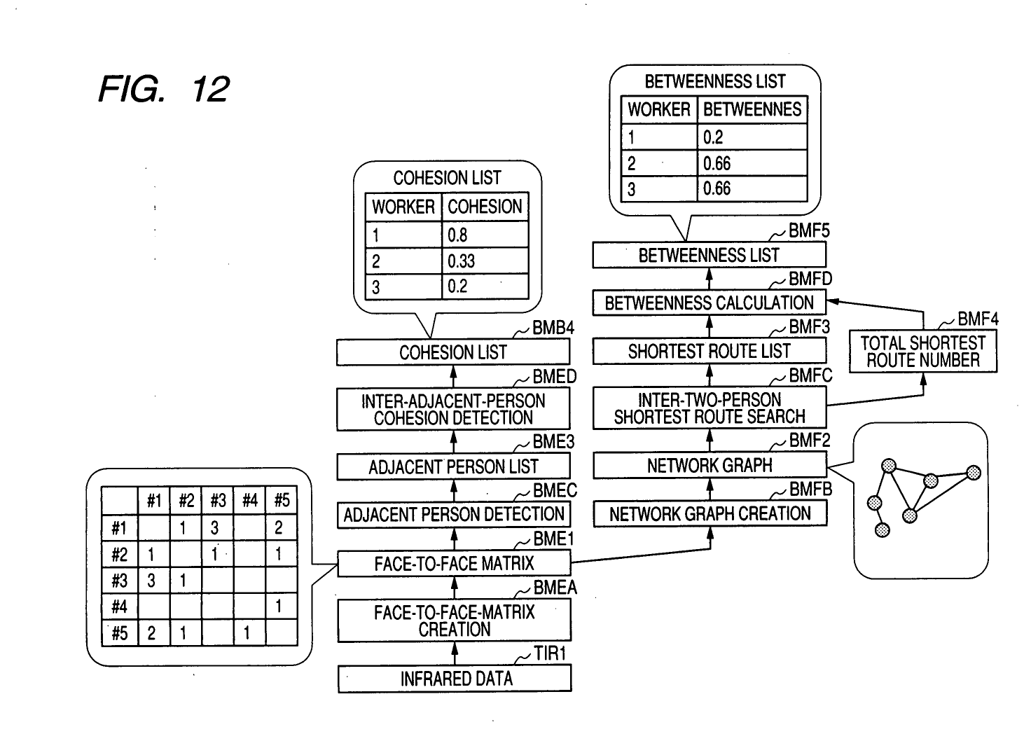

In the system of the present invention, the above “cohesion” and “betweenness centrality” are calculated with the number of face-to-face detections of the infrared rays in a certain period as the number of communications. As the time, a constant interval such as 24 hours or one weeks can be set, or an entire period from a project start to a subject time can be set when a period is determined in the business project. In this example, a description will be given of a calculating method in which the business cycle is one day unit, and past 24 hours are provided. FIG. 12 shows a flow of the method.

The “cohesion” of the respective workers at a certain time t is obtained by the following face-to-face matrix creation (BMEA), adjacent worker detection (BMEC), and inter-adjacent-workers cohesion detection (BMED). The face-to-face matrix is that the number of face-to-face between the respective two workers of n workers is expressed by n*n matrix. The worker 1 to the worker n are assigned to rows in the order, and similarly the worker 1 to the worker n are assigned to columns in the order. When m communications are conducted between the worker i and the worker j, a value m is inserted into i×j.

In the face-to-face matrix creation (BMEA), a list extracting the infrared detection data between the subject time t and the past 24 hours (t to 24 hours) which is a subject period is first created. Subsequently, a total of the number of communications between a certain worker I and another worker j is obtained from that list, and the value is stored in i×j of the face-to-face matrix (BME1). This operation is conducted on all of i and j to complete the face-to-face matrix (BME1).

In a subsequent adjacent worker detection (BMEC), an adjacent worker list (BME3) extracting workers who communicate directly with the certain worker i is created. The workers who communicate directly with the worker i are understood by detecting a column whose value is larger than 0 among the row i of the face-to-face matrix (BME1). For example, when the worker 1 communicates with three persons of the worker 2, the worker 3, and the worker 5, a list of {2, 3, 5} (BME3) is created.

In the subsequent inter-adjacent-workers cohesion detection (BMED), elements are extracted from the list (BME3) two by two, and it is determined whether a communication is made between two elements, or not. For example, three pairs of {2,3}, {2,5}, and {3,5} are extracted from the list (BME3) of {2,3,5}. It is checked whether the value of subject cell of the face-to-face matrix (BME1) is larger than 0, or not, with respect to the respective elements. For example, when the element of 2×3 of the face-to-face matrix (BME1), and the element of 3×2 as the occasion demands are checked with respect to {2,3}, and when the value is larger than 0, a communication is conducted. On the other hand, when the value is 0, no communication is conducted. In this example, it is assumed that a value resulting from dividing the number of elements determined that there is a communication by tile number of all pairs is the cohesion of the worker i in the inter-adjacent-worker cohesion list (BME4). For example, when a communication is made by two pairs of workers among the above pairs {2, 3}, {2, 5}, and {3, 5}, 2/3(0.67) is the cohesion related to the worker i, and stored in the element i of the cohesion list (BME4) between the adjacent workers. The cohesion is calculated with respect to all of the workers to complete the cohesion list (BME4). The value in the list is a value of “cohesion” of the respective workers at a certain time t.

Subsequently, the “betweenness centrality” of the respective workers at the certain time t is obtained by the following face-to-face matrix creation, network graph creation (BMFB), inter-two-workers shortest route search (BMFC), and betweenness centrality calculation (BMFD). The face-to-face matrix creation is identical in the processing with the above face-to-face matrix creation (BMEA).

Subsequently, the network graph creation (BMFB) constitutes a network graph (BMF2) that expresses the number of communications between the respective pairs of workers as the weight of a line between the nodes with the respective workers as nodes on the basis of the face-to-face matrix (BME1). When the number of communications between two workers is 0, a line is not drawn between two workers.

In the subsequent inter-two-workers shortest route search (BMFC), one worker i and another worker j are selected to obtain the shortest route list (BMF3) on the network graph (BME2) between the two workers. The shortest route search in the network graph is obtained by a generally known Dijkstra method. In this example, in order that the communication frequently passes through a certain route by priority, the shortest route is obtained by expressing the inverse of the number of face-to-face by the weights of the respective routes. When plural shortest routes exist, all of the shortest routes are searched as the number of total shortest routes (BMF4).

In the subsequent betweenness centrality calculation (BMFD), the betweenness of the respective nodes on the shortest route list (BMF3) is updated. 1/total shortest route number (BMF4) is added to the betweenness of the respective nodes on the shortest route list (BMF3). This activity is conducted between the worker i and the worker j, thereby enabling the betweenness of the respective workers to be calculated. A value of the betweenness list (BMF5) that could be finally completed is a value of “betweenness centrality” of the respective workers at the certain time t.

With the above operation, as the information related to the quality of the activity of the respective workers at the respective times, the degree of concentration, the face-to-face time, the positiveness in the face-to-face, the cohesion with members of a team, and the centricity of the communication in an organization can be obtained.

As described above, the physical quantity obtained through the sensor is converted into information representative of the quality of activity, thereby enabling significant information that can be understood by the worker to be obtained.

Subsequently, a method of associating data acquired from the PC device with information related to the quality of the activity which has been obtained above, and calculating the quality of the activity related to certain activity on the PC and a certain file resultantly obtained by the activity. In this example, the activity is a creation of a certain document or a communication by an e-mail, information collection on the internet, software development, and so on. For example, in the PC, the operation is directed to a coherence of edition or browser on the PC which can be identified by application, file, process, or window title such that a specific application is concentratedly used within a certain period, or plural files in which a certain specific file or a certain specific words are frequently issued are continuously edited or browsed.

The sensor net system according to this embodiment first specifies the PC device and the sensor device of the subject worker according to the worker identification information storage table TID1. Then, the sensor net system produces the activity condition list representative of which activity has been conducted at the respective times according to data acquired by the PC operation/state monitoring program. Then, the activity condition list, and the activity quality list obtaining the values of the respective qualities related to the activity according to the above obtained concentration degree, a face-to-face time, the positiveness of the face-to-face, the cohesion with the members of a team, and the centricity of the communication in an organization are created.

Hereinafter, a description will be given of a procedure of starting the activity with a window title as an example as a procedure of the activity condition list creation.

First, the PC device and the sensor device of the present subject worker are specified by using the worker identification information storage table TID1. More specifically, the worker designation information (BMG7) given as the present subject is searched from the sensor identifier management table TSDID of the worker identification information storage table TID1 and the PC identifier management table TPCID. The subject device is understood from the RPCID and RSDID on the row where the information corresponding to the worker designation information (BMG7) exists in RUID. They are the PC identifier UPCID1 and the sensor identifier USDID1.

Subsequently, data of the OC identifier UPCID1 is extracted with respect to the PC operation/state log by the subject worker data extraction (BMG9). The activity condition list (BMG1) indicative of whether a certain activity has been conducted at the respective times in the activity condition determination (BMGA) with respect to the extracted data, or not, is created. At the subject time t, the PC operation/state log is scanned, a row including the time t is found, and “1” is inserted assuming that the subject activity w is conducted when the character string of the window title string “WRTITLE” on that found row is matched with the character string representative of the activity w, and “0” is inserted assuming that the activity w is not conducted when the former is not matched with the later. The activity is conducted at the respective times in the time series, thereby generating the activity condition list (BMG1) indicative of whether the subject activity w is conducted at the respective times, or not, by a given time unit (for example, second unit).

In this example, in the real activity, because there is a case where plural files are dealt with at the same time, or plural applications are accessed at the same time, it is not practical to mechanically specify one activity such that a certain activity is merely executed from one time to another time. In other words, even if one activity is conducted in a certain moment, there is the possibility that another activity is conducted in time zones around the moment. Therefore, there is the necessity of improving the data of an activity condition taking the time zones around the moment into consideration. For that reason, noise removal (BMGB) is conducted on the activity condition list (BMG1). As in the noise removal (BMAC) in the above calculation of the concentration degree, a series such as “0000000111111111111” obtained by removing a momentary change from a time series change of an activity condition, for example, a series such as “0001000111111001111” taking the time zones around the moment into consideration. This activity is conducted at the respective times in the time series manner to generate the updated activity condition list (BMG2). When the above noise removal process is conducted, the activity can be specified taking the time zones around the moment into consideration, thereby making it possible to obtain the results more reflecting the real activity. Then, the values of the respective qualities related to the activity are obtained according to the activity condition list (BMG2) as well as the above obtained degree of concentration, the face-to-face time, the positiveness degree of the face-to-face, the cohesion with the members of a team, and the centricity of the communication in an organization. In this example, the calculating method will be described with reference to the degree of concentration.

First, an effective activity time list (BMC3) that extracts the data of time during which the activity has been conducted by the effective activity extraction (BMGC) is created from the activity condition list (BMG2). Then, data of the present subject worker is extracted from the above sensor identifier USDID1 by the subject worker data extraction (BMA10). Then, in the concentration list creation BMA11, a concentration list (BMA3) that stores the degree of concentrations at the respective times is created in the method shown in FIG. 11. All of the degree of concentration lists (BMG4) related to the time during which the subject activity has been conducted are extracted with respect to that data by the specific time data extraction (BMGD). An average of the degree of concentration values related to the extracted data is calculated (BMGE) to calculate the degree of concentration (BMG5) of the subject activity and store the calculated degree of concentration in the activity quality list (BMG6). The activity quality list is a table in which the quality calculation values related to the activity name and the subject activity are stored. The quality data of the subject activity other than the degree of concentration is obtained to acquire all the quality values related to the subject activity.

The above step is obtained with respect to all of the activities, respectively, thereby making it possible to obtain the quality value of all the activities.

As described above, the information related to the quality of activity obtained from the sensor data and the information obtained from the PC are associated with each other on the basis of the time information, thereby making it possible to associate the action of a human being continuous and the sensor data being fragmentary information which are different in property from each other. Further, the activity quality list is created, thereby making it possible to grasp the quality of the entire activity since the activity start till the activity end, and it is possible to grasp in what condition the worker operates in the real environment, and in what state the worker creates a file.

As described here, it is possible that all of the activities are calculated in a lump to obtain the activity quality list (BMG6). On the other hand, it is possible to interactively obtain the quality related to a certain specific activity according to a request of the user.

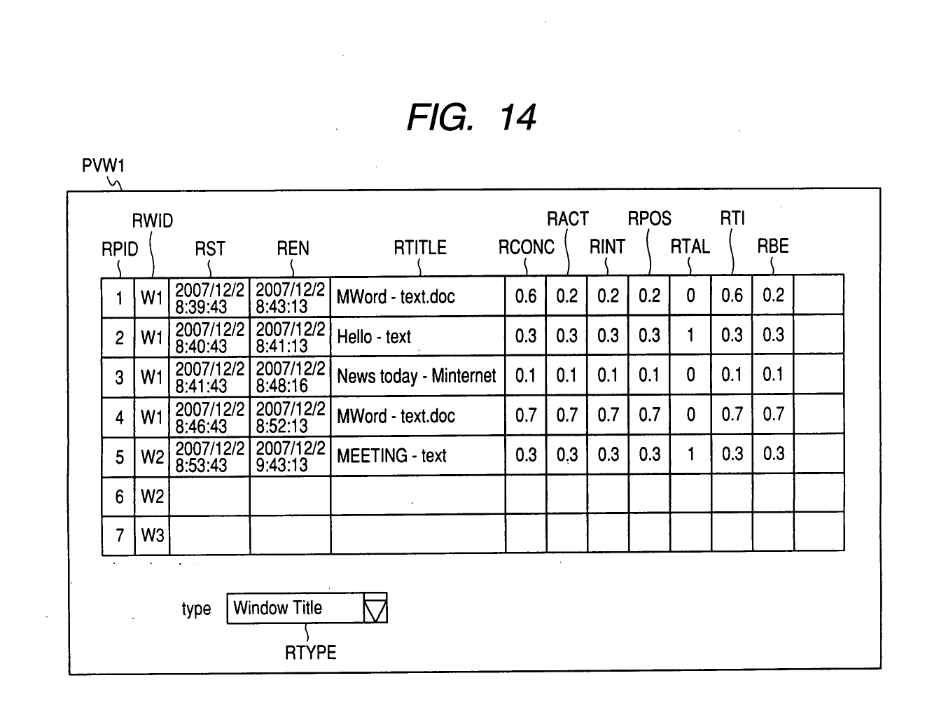

FIG. 14 is a diagram showing an example of a screen for displaying the calculated quality of activity. A screen PVW1 is generated from an activity quality visualization program PV1, displayed on the computers PC1 of the respective workers on the network, or displayed on the sensor devices SD1 of the respective workers. In the screen PVW1, the type of data to be used for calculation is first selected by a type selection tab RTYPE. For example, a window title, a process, an application name, a file name, and the like can be selected. The activity quality calculation shown in FIG. 13 is executed according to the selected type to display the results of calculation. In a table of PVW1, each of columns corresponds to one activity. There are indicated serial numbers of activity in RPID, worker identification number in RWID, activity start time in RST, activity end time in REN, window title in RTITILE, degree of concentration in RCONC, activity degree in RACT, face-to-face frequency in RINT, positiveness degree in RPOS, the degree of speech in RTI, and the betweenness in RBE. For example, the number of face-to-face workers, a speech time, and so on can be displayed as different data. As the display data, it is possible to display only a given worker or the members of a given team, or display data of a specific time, and its average.

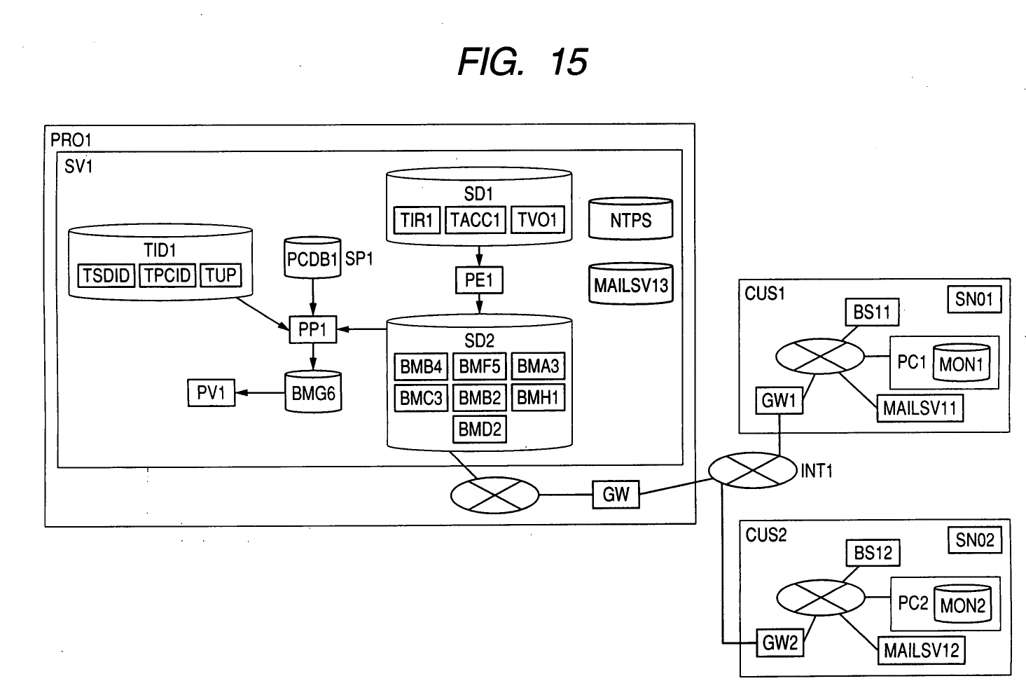

FIG. 15 is a diagram showing an example of a system when a service providing the activity quality assessment is conducted according to one embodiment of the present invention. PRO1 is a provider that provides the activity quality assessment service. On the other hand, organizations CUS1 and CUS2 are different organizations/enterprises, respectively, and parties using the quality assessment service. Within the organization CUS1 are a sensor device SN01, a base station BS11, a computer PC1, a PC operation/state monitoring program MON1, and a mail server MAILSV11. The operation of the PC operation of the worker and the sensor information which have been acquired by using the above devices according to the method of the present invention are stored in the management server SV1 within the provider PRO1 through a gateway GW1 and an internet INT1. The same data as that stored in SV1 in FIG. 1 is stored in SV1. The organization CUS2 has the same system as that of the organization CUS1.

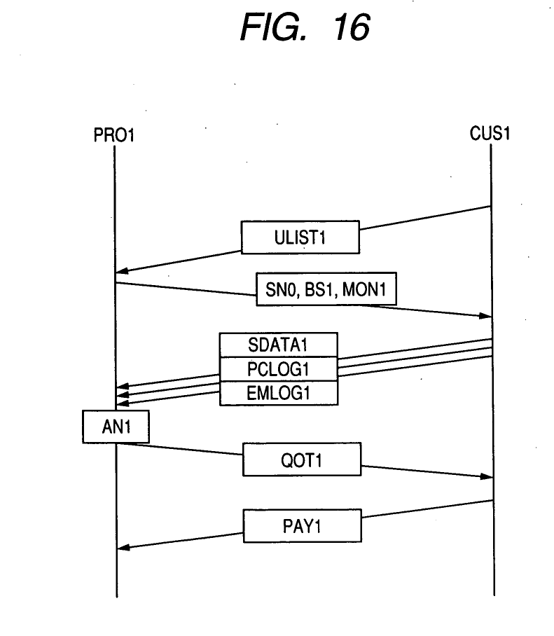

FIG. 16 is a diagram showing a procedure of conducting the activity quality assessment of the present invention in the configuration of FIG. 15. The list ULIST1 is first supplied to a provider PRO1 from the organization CUS1. The provider PRO1 provides a sensor device SN0, a base station device BS1, and a PC operation/state monitoring program MON1 required on the basis of the above list. When the organization CUS1 starts the monitoring of the operation by using those elements, sensor data SDATA1, PC operation/state monitoring log PCLOG1, and log EMLOG1 of e-mail are transmitted to the provider PRO1. In the EMLOG1 are stored a sender, a receiver, and transmission/reception times of the mail as information for recognizing the transmission and reception of the mail. The provider PRO1 that has received the information executes the method of the present invention within the server of FIG. 15 by means of an analysis engine AN1, thereby analyzing the quality of the activity and providing, for example, the activity quality information of FIG. 14 to the organization CUS1 as the result QOT1. The provider PRO1 acquires the compensation PAY1 for that information.

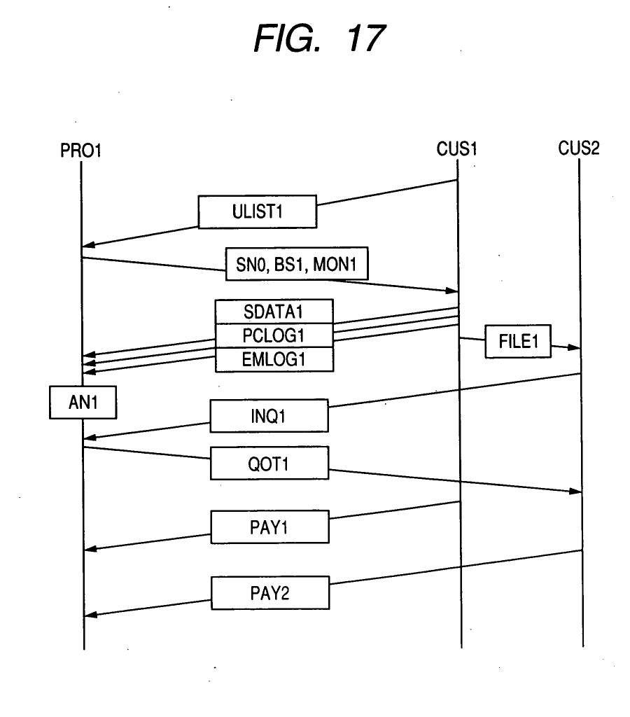

The above description is given of an example in which the log EMLOG1 of e-mail is transmitted from the organization to the provider. However, even if only the sensor data or the PC operation/state monitoring is transmitted, it is possible to provide a service for calculating the activity quality information to provide the activity quality evaluation according to the present invention. The same is applied to an embodiment described in FIG. 17 and later.

FIG. 17 is an example in which another organization refers to the quality of activity of one organization unlike FIG. 16. The process during which the provider PRO1 acquires and analyzes the activity information of the organization CUS1 and the sensor data is identical with that in FIG. 16.

Now, it is assumed that the activity results of the organization CUS1, for example, an electronic file FILE1 created by the organization CUS1 is received by the CUS2. In the following procedure, the organization CUS2 is capable of knowing the quality of the subject file. An inquiry INQ1 about the quality information of the file FILE1 is transmitted to the provider PRO1 from the organization CUS2. The inquiry ING1 includes information for identifying the file FILE. The provider PRO1 confirms the subject file, for example, on the basis of the signature of the file, the creation source, or the like, and provides the organization CUS2, for example, with the activity quality information of FIG. 14 as the result QOT1. The organization CUS2 is capable of knowing the quality of the file FILE1 by viewing the above information. The organization CUS2 pays the compensation PAY2 to the provider PRO1. Also, the provider PRO1 receives the compensation PAY1 related to the quality assessment substitute of the organization CUS1 from the organization CUS1.

Through the above method, the organization CUS2 is capable of knowing the quality of the file FILE1 under the authentication of a third party. As a result, the organization CUS2 is capable of assessing the organization CUS1 and the activity thereof, and comparing organization CUS2 with another organization. Conversely, the organization CUS1 is capable of exhibiting its achievement through the third party, and is capable of requesting the compensation for the file FILE1 and the activity for creating the file FILE1, and exhibiting the superiority as compared with another organization.

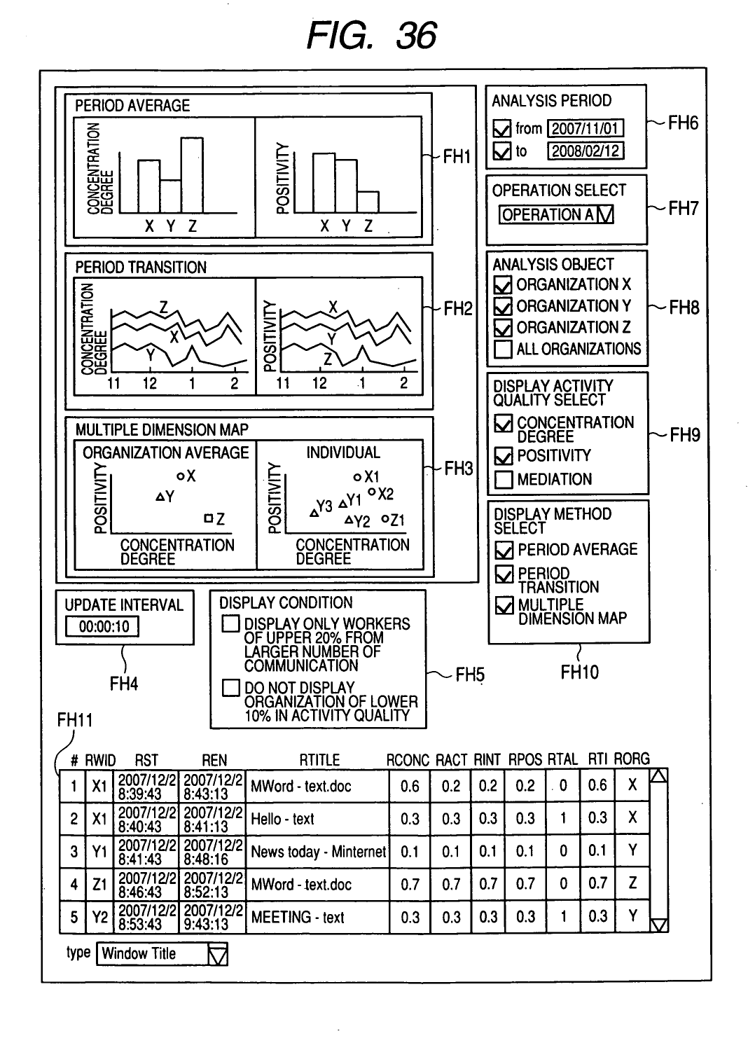

Also, the comparison between the organizations can be conducted through an interface shown in FIG. 36.

Reference FH7 is an interface for selecting the activity, and the user designates the interested activity by the activity name, the file name, or the like. The above provider PRO1 searches the activity or file including the name thus designated, and displays the searched object ax with FH1 which will be described later.

In this situation, there is provided an interface that designates the organization to be analyzed as with FH8, and only the organization designated by the user is to be processed, thereby making it possible to display only the organization particularly interested by the user.

Also, the activity quality index to be analyzed is disposed in the interface as with FH9, thereby making it possible to process only the quality of activity designated by the user.

With provision of an interface that designates a display mode as with FH10, it is possible to select the format easily viewable by the user.

The average or total of the activity quality of the subject activity in the subject period is displayed by the display such as FH1, thereby making it easy for the user to know only an interested period.

Also, a change in the quality of activity is displayed in a time series as with FH2, thereby making it possible to know whether the management of the quality is appropriately conducted, or not.

Also, the average and dispersion of the respective organizations are displayed on plural quality assessment indexes as axes as with FH3, thereby making comparison between the organizations easy.

Also, it is possible to update those graphs according to sensor data or subjective assessment data which is successively transmitted in real time. The frequency of update can be designated by an interface such as FH4.

Also, the conditions of the organization to be displayed are selected as with FH5, thereby making it possible to directly provide information which the user wishes to view. For example, only an organization that is large in the number of communication is displayed, or an organization that is low in the quality of activity is not displayed.

Also, an interface that sets the subject period is provided as with FH6, and only the data in a period designated by the user is processed, thereby making it possible to display only a period interested particularly by the user.

FH11 is a history of the quality of activity described in FIG. 14, and the history is displayed together, thereby making it possible that the user views the interested activity and quality of the organization in a graph.

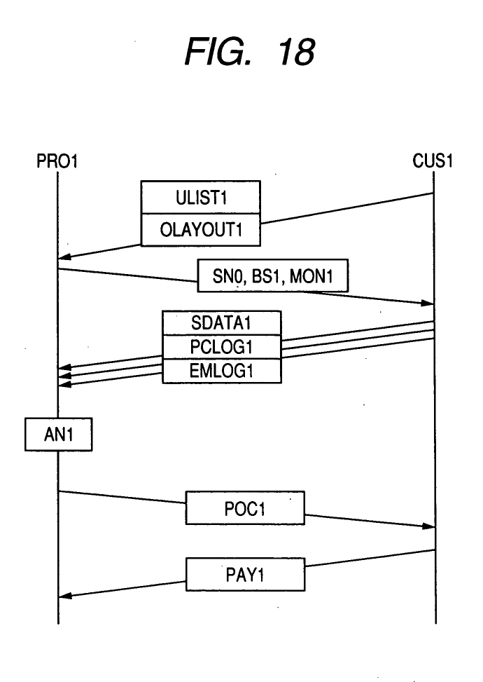

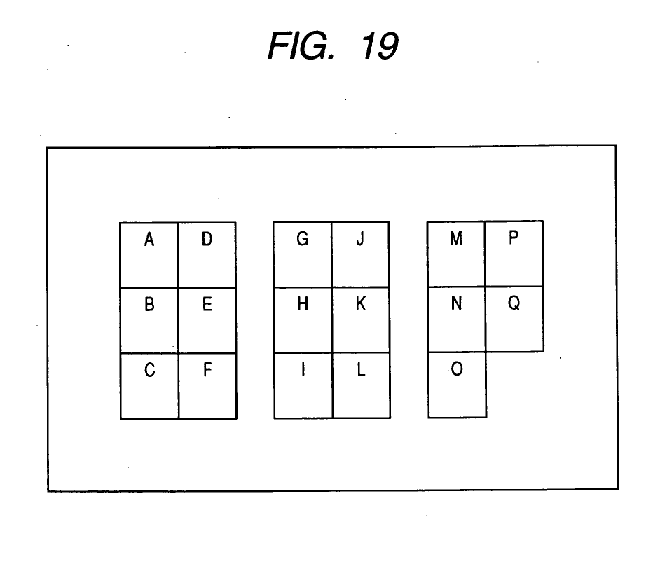

FIG. 18 shows a flow for conducting an organic alternation proposal service in the configuration of FIG. 15 according to another embodiment of the present invention. The process of acquiring the activity data of the organization CUS1 and analyzing the acquired data by the provider PRO1 is identical with that of FIG. 16. However, an office layout OLAYOUT1 of the organization CUS1 is supplied to the provider PRO1 from the organization CUS1. An example of the office layout OLAYOUT1 is shown in FIG. 19. In the example, there are 17 seats A to Q.

The organization alternation proposal service shown in FIG. 18 reflects the real communication or quality of activity of the organization, and provides a proposal POC1 of a more desirable seat arrangement. In this description, as the desirable seat arrangement, communications are usually frequently conducted, and the workers that are high in the quality of activity when the communication is conducted are arranged closer to each other. Also, the calculation expression of the weight of the graph which will be described later can be defined on the basis of an idea in which the workers who hardly usually communicate with each other are arranged close to each other.

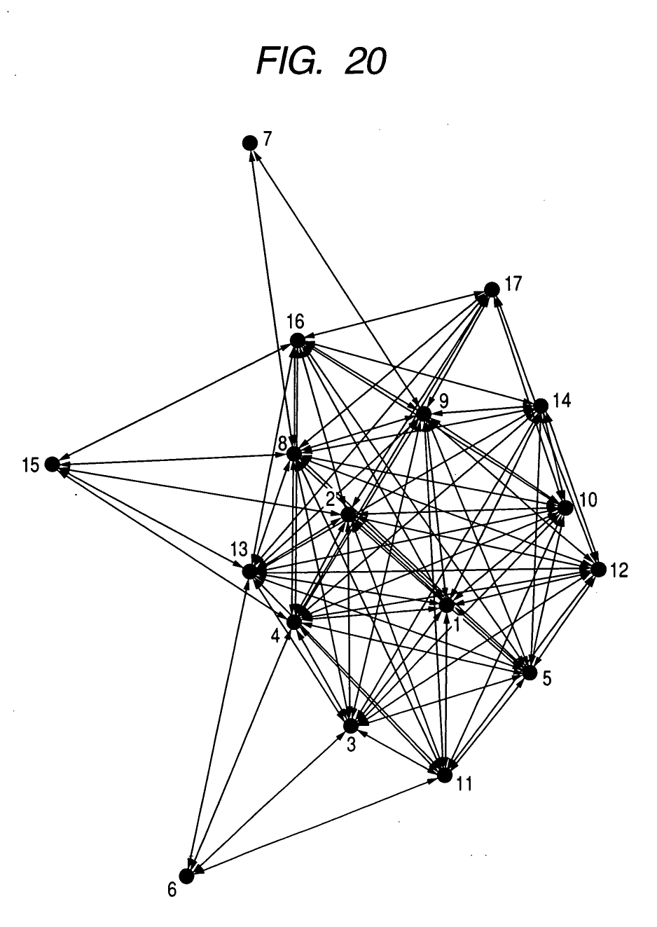

First, a network graph is created by a method shown in FIG. 12 by the aid of the face-to-face information of infrared rays of the sensor data SDATA1. In this embodiment, an exchange of e-mail is treated as a communication, and a network structure close to a more real communication structure can be obtained which reflects both of the physical communication and the e-mail communication. For example, one transmission of e-mail is replaced with one infrared face-to-face to create a graph. For example, a network graph shown in FIG. 20 is resultantly obtained. Then, the degree of influence of the respective communications on the quality of activity of the worker is calculated as an activity quality influence degree, and added as the weight of the respective connections in the above network diagram to update the network graph. This is because the workers having such a communication with each other as to improve the quality of activity are seated close to each other.

Hereinafter, a description will be given of an example of calculating the degree of an influence of a worker 2 on a worker 1, calculating the weight between the worker 1 and the worker 2 on the basis of the degree of calculated influence, and updating the network graph.

First, in order to obtain the degree of influence of the worker 2 on the worker 1, a face-to-face time is extracted, and the quality is calculated. The face-to-face time extraction is to specify a time at which the workers 1 and 2 face each other, and the time is extracted with reference to a table TIR1 of the infrared data in the database SD1 that stores the sensor data SDATA1 therein. Then, the quality at the extracted time is calculated. There are several qualities as described above. The degree of concentration will be exemplified in this case. The degree of concentrations of the worker 1 at the respective times can be acquired by the method described with reference to FIG. 11. Therefore, the influence of the worker 2 on the degree of concentration of the worker 1 can be estimated on the basis of a time at which the worker 1 faces the worker 2, and the degree of concentration at a time after a given period of time (for example, 1 hour) since face-to-face. In this example, the degree of concentrations in one hour after the face-to-face time are averaged to obtain the degree of influence of the worker 2 on the degree of concentration of the worker 1. Conversely, the degree of influence of the worker 1 on the degree of concentration of the worker 2 is obtained in the same manner. Finally, the degrees of those two influences are averaged to obtain the degree of influence between the workers 1 and 2.

Then, in order to increase the weight of a graph more as the degree of influence is higher, that is, in order to seat the workers closer to each other with better influence, it is proposed that the result of multiplying the number of face-to-face by the value of the degree of influence is regarded as the weight of the graph. As a result, the weight between the worker A and the worker B in the network graph shown in FIG. 20 is calculated according to (the number of infrared detections between A and B+the number of mail transmission/reception between A and B)*(the degree of influence between A and B). The network graph of FIG. 20 is updated by the aid of the information on the calculated weight so that the workers are arranged closer to each other as the weight is larger.

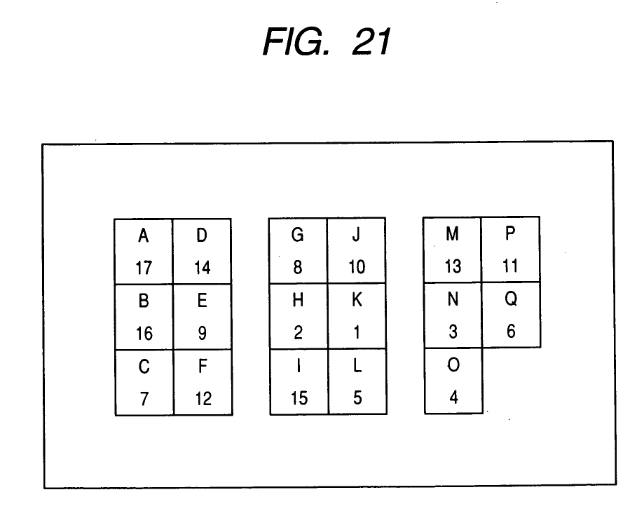

Then, a desired seat arrangement is calculated according to the network graph obtained above. This is that the network graph of FIG. 20 is mapped on an office layout of FIG. 19 while the positional relationship is kept as much as possible, and the seat assignment shown in FIG. 21 is determined. FIG. 21 shows an example in which a worker 17 is assigned to a seat A. Hereinafter, a method of calculating a desired seat arrangement will be exemplified, and various combination optimization algorithms are applicable. First, as an initial procedure, one of workers at ends of the graph is selected, and then stored in an assignment candidate storage arrangement QUEUE. The arrangement QUEUS is an FIFO type queue, and candidates stored in advance are to be assigned in the order. In this example, it is assumed that a worker 6 is first selected. The worker can be selected manually, or can be automatically obtained, for example, in such a manner that distances among all the workers or the graph are obtained to search a worker having the longest distance. The following procedure is repeated until the arrangement QUEUE becomes free. First, a leading worker is extracted from the arrangement QUEUE, and then assigned to a seat at an end of alphabets among unassigned alphabets on the office layout. That is, the workers are assigned to seats Q, P, O, N, . . . in the stated order. According to that order, workers who communicate with the extracted workers but have not yet been stored in the arrangement QUEUE are stored in the arrangement QUEUE. For example, when it is assumed that the worker 6 is first stored in FIG. 20, workers 11, 4, 3, and 13 which are connected to the worker 6 is then stored. The order is a larger order of the information on the weight obtained in advance. With that operation, the assignment of this worker is completed. The above operation is repeated until the arrangement QUEUE becomes free, that is, the assignment of all the workers is completed. With the above arrangement, the workers who frequently communicate with the workers to which seats have been already assigned are arranged in the order, a communication now required at work is smoothly taken.

A change in the seat arrangement in the office is exemplified in the above. An exchange in the members within a group of the organization can be also proposed by using the same method. For example, FIG. 19 shows not the layout of an office but the member configurations of a group. In FIG. 19, there are three teams, and 5 or 6 members are in each of the teams. When the workers are assigned by the above method, the workers who frequently communicate with each other can be grouped in the same team. Also, as another method, there is a method in which the graph in FIG. 20 is clustered by the density of connections, or parting lines are drawn in a portion where connections are sparse on the graph, that is, such a combination that the number of connections that step over the parting lines becomes minimum is obtained.

As described above, the degree of influence between the workers is calculated by the aid of the action index indicative of the action state (degree of concentration) to create the network graph between the workers on the basis of the calculated degree of influence and the face-to-face frequency. Then, it is possible to propose the business improvement of the organization such as a change in the seat arrangement in the office or an exchange in the members within the group.

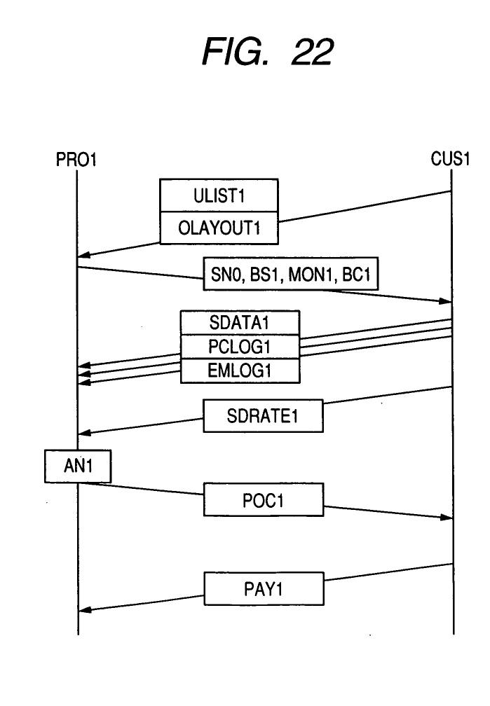

Subsequently, as another embodiment of FIG. 18, FIG. 22 shows a flow of an alteration proposal incorporating the subjective assessment of the worker. The method of FIG. 18 is optimized by using the assessment index such as the degree of concentration, but that the method is suitable for the individual characteristics of the workers which are desired by the respective workers is limited.

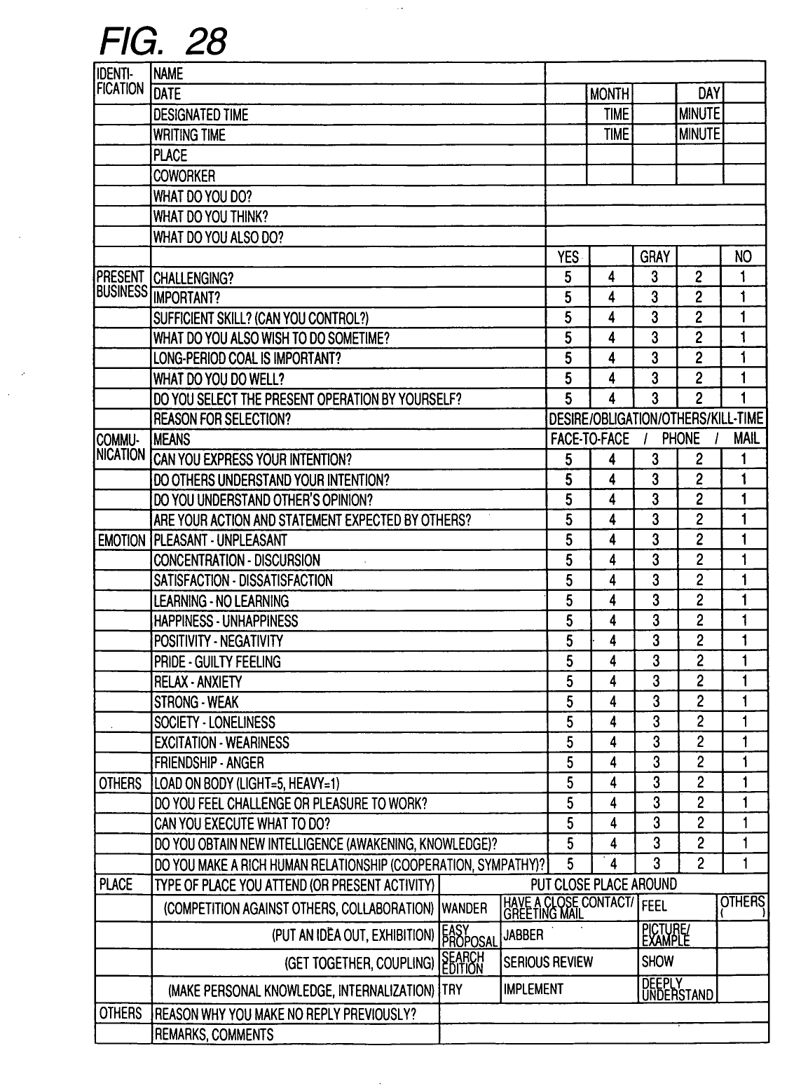

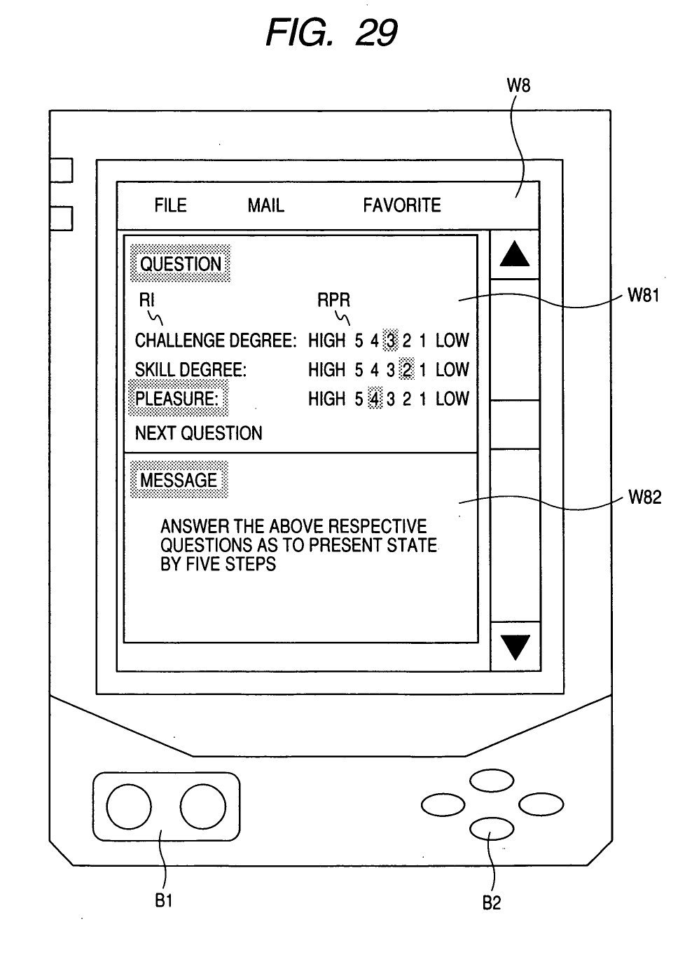

Under the circumstances, the condition is determined by the worker, and the determined condition is altered as a weight. In a flow of FIG. 22, SDRATE1 is the individual subjective assessment of the worker. The worker periodically assesses the subjective assessment, for example, the degree of satisfaction, the degree of challenge, interest, or the positiveness degree by 5 levels, and provides the assessment. The assessment can be written on a paper, or can be input by the worker by using a questionnaire on web, a button on the sensor device. FIG. 28 is an example of a questionnaire on a paper, and FIG. 29 is an example in which assessment is conducted on a sensor device. The frequency of submission is, for example, once a hour, or once a day.

Subsequently, the weights among the respective workers are calculated as in the example of FIG. 18. In this example, (the number of infrared detections between A and B+the number of mail transmission/reception between A and B)*(the degree of influence between A and B)*the degree of influence between A and B is obtained in each of the time zones (for example, by day unit), and then averaged to obtain a weight between A and B. With the above operation, if there is a tendency that the assessment is high when the worker A sees the worker B, the workers A and B are arranged close to each other. On the contrary, if the assessment is low, they are arranged far from each other.

In this way, the subjective assessment of the worker is reflected to calculate the weight between the workers, and the network graph is created, thereby making it possible to propose the business improvement which is desired by the workers or suited for the characteristics of the workers.

Also, an example in which the worker assesses himself is described above. However, a third party can assess the worker, for example, a manager assesses his subordinate. As the advantage, it is possible to propose the business improvement that is more suited for the preference of the manager.

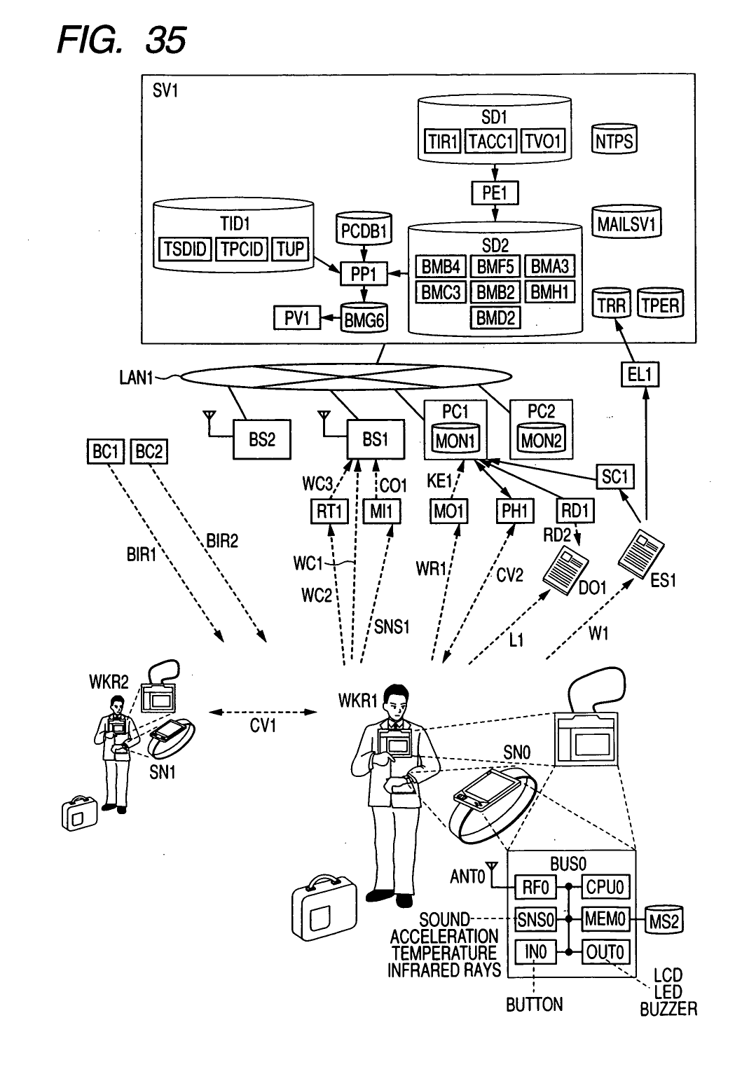

FIG. 35 is an example of the configuration in an embodiment of FIG. 22. When a questionnaire ES1 is prepared on a paper as shown in FIG. 28, the questionnaire is read by an OCR or a scanner SC1 to recognize the assessment, and the assessment is stored in an action assessment log TRR of the server SV1 on the network LAN1. Also, it is possible that the assessment is manually subjected to digitalization EL1. When assessment is conducted on the sensor device as shown in FIG. 29, data is transmitted to the base station BS1 wirelessly, and can be then stored in the action assessment log TRR of the server SV1 in the same manner.

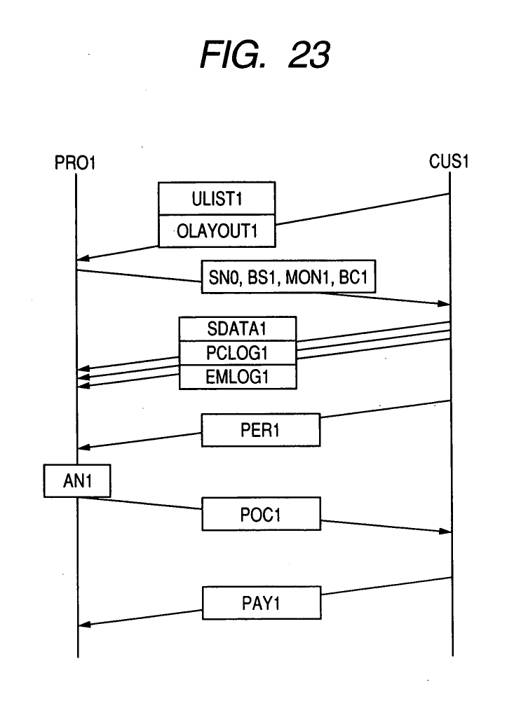

FIG. 23 is another embodiment of FIG. 18. In this example, a performance PER1 per se of activity is taken into consideration instead of the subjective assessment of the worker. The performance directly exhibits the activity achievement, for example, sales, the number of transactions of activity, or the like, which are acquired from a system that records the history of sales task, and can be stored as indicated by a business log TPER in FIG. 35. Like the example shown in FIG. 22, the performance is calculated, for example, once an hour, or once a day, and the weights among the respective workers are calculated on the basis of the calculated performance. That is, (the number of infrared detections between A and B+the number of mail transmission/reception between A and B)*(the degree of influence between A and B)*the degree of influence between A and B*business performance is obtained in each of the time zones (for example, by day unit), and then averaged to obtain a weight between A and B. With the above operation, if there is a tendency that the performance is high when the worker A sees the worker B, the workers A and B are arranged close to each other. On the contrary, if the performance is low, they are arranged far from each other.

The weights among the workers are calculated on the basis of the activity achievement to create the network graph, thereby making it possible to propose the business improvement that reflects the business performance.

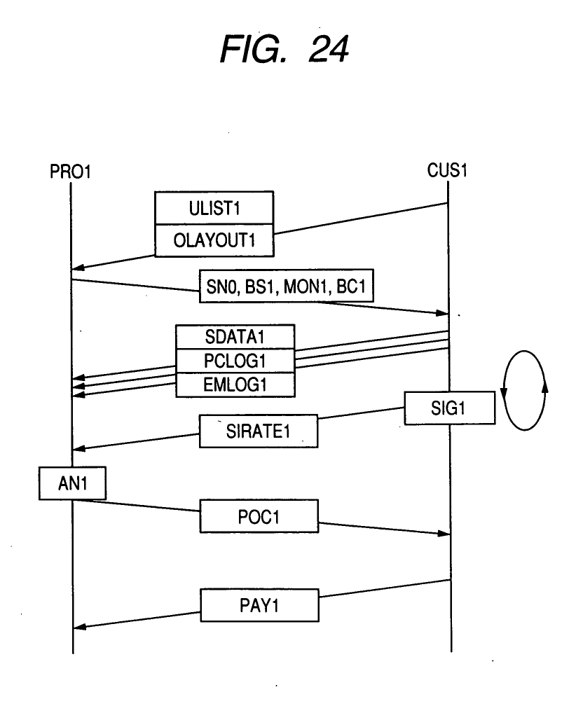

FIG. 24 shows a method of associating the quality of activity, the subjective assessment, and the activity contents at a given time with the sensor information. In FIG. 22, the subjective assessment in a given constant period (for example, one day) is used. In this example, the subjective assessment at a specific time is acquired further at the micro level. The data is repetitively acquired several times, thereby making it possible to investigate a given specific acceleration frequency, an occurrence frequency, and a correspondence between the subjective assessments.

In FIG. 24, the sensor device that is worn by the worker of CUS1 transmits a signal SIG1 to a worker wearing it at a given time. In this example, the signal SIG1 notifies the worker of a time when the subjective assessment is recorded through sound or light. For example, sound is ringed, for example, cyclically once an hour, or at random, at intervals of one hour to two hours. For the worker, the subjective assessment SIRATE1 is recorded as soon as the worker hears the sound in a silent state, and transmitted to a provider PRO1. The sensor data and the operation history of the PC are transmitted as usual. Accordingly, the provider PRO1 is capable of acquiring the subjective scoring at a given moment and sensor data at the moment.

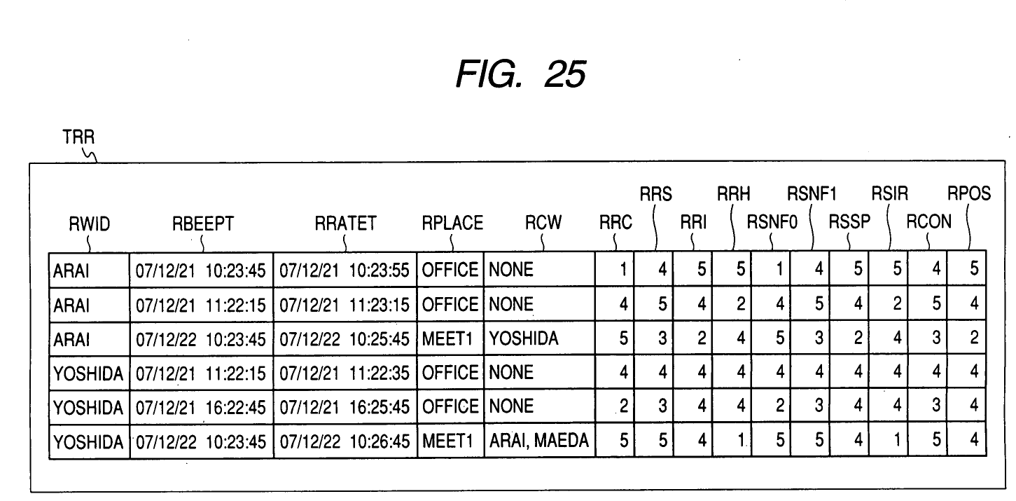

As a result, it is possible to obtain the action assessment log TRR that associates the subjective assessment of the worker with the action index indicative of the action state as shown in FIG. 25. In the log TRR is automatically stored a worker identifier RWID, a time RBEBPT with no signal, and a time RRATET when scoring is made. Then, as information recorded by the worker, for example, there are stored a place RPLACE, a coworker RCW, a challenge degree RRC, skill exhibition degree RRS, importance RRI, and happiness RRH. Also, as information obtained from the sensor, the quantity RSNF0 of acceleration 0 to 1 Hz in a constant period of time (for example, 1 minute or 10 minutes) before and after the signal, the quantity RSNF1 of the acceleration 1 to 2 Hz, the statement ratio RSSP in the constant period of time, the number of face-to-face detection RSIR in the constant period of time, the degree of concentration RCON in the constant period of time, and the positiveness degree RPOS in the constant time are calculated, and stored. The action assessment log TRR is stored in the management server SV1.

In the above, an example in which the signal SIG1 is ringed cyclically or at random is described. However, the provider PRO1 analyzes data in real time, thereby making it possible to more effectively collect data. When a specific action state is detected, for example, when a combination of delta indicative of the action state that has not appeared up to now is detected, a command is transmitted to the sensor device worn by the worker from the provider PRO1 through the internet INT1, the gateway GW, and the base station BS1 to ring the signal. Otherwise, for example, as for the action state that frequently appears, it is possible that the signal is ringed, and the number of samples increases to enhance a precision of data related to the activity specific to the worker. Also, it is possible to ring the signal when movement (for example, walking) that is the discontinuity of the action is detected.

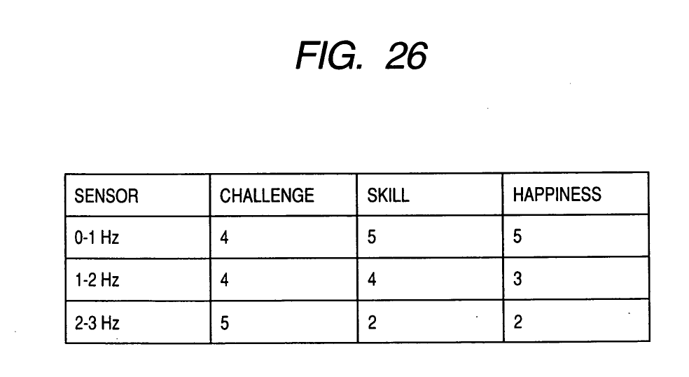

An example of obtaining the subjective assessment related to the respective specific actions or the sensor data from the above action assessment log TRR is shown in a frequency to subjective assessment map showing a relationship between the frequency of acceleration and the subjective assessment shown in FIG. 26. This determines a characteristic frequency with respect to the respective samples (respective rows) of the action assessment log of FIG. 25. As this method, there are a method of taking the frequency component that most appears in a constant period of time before and after the signal, or a method of selecting a most different frequency as compared with the average frequency distribution. Then, as for the samples classified into the same frequency band, the average of the respective subjective assessment values is calculated, and stored in a table. As a result, the frequency to subjective assessment map can be obtained. When the distribution of data and the standard deviation are stored in addition to the average, it is possible to know how much the average value stably appears.

Also, a relationship between the respective actions and the subjective assessment can be exhibited by using the correlation analysis for this action assessment log TRR. For example, a correlation coefficient of the row RRC representative of the challenge degree and the column RCON of the degree of concentration is obtained. The correlation coefficient is obtained between −1 and 1 through a method of obtaining a general Pearson's product moment correlation coefficient. When the correlation coefficient is close to 1, it is understood that the challenge degree and the degree of concentration have a relationship for the worker.

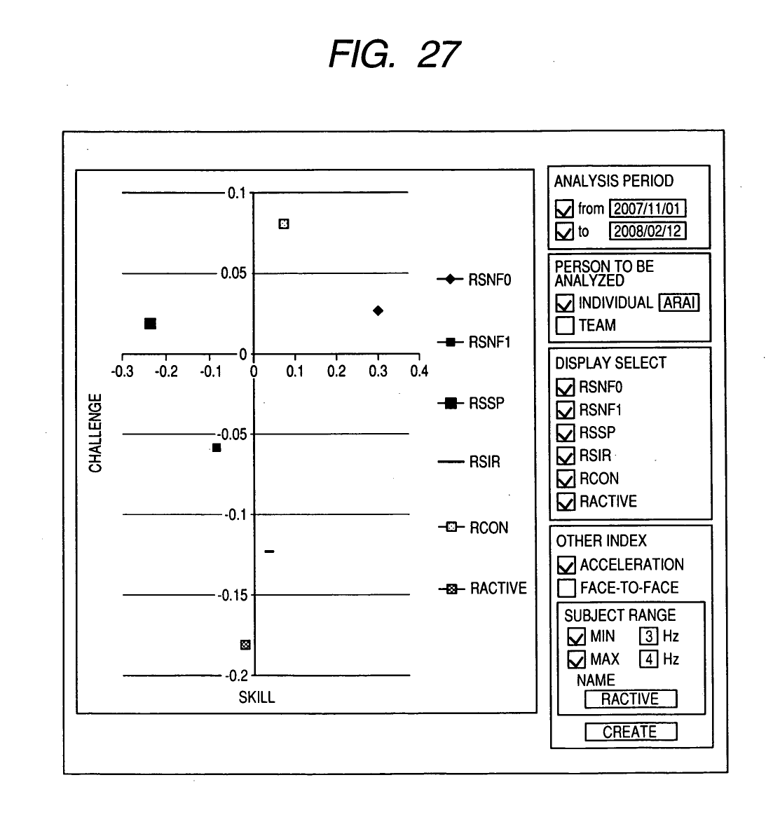

An example in which the calculation of the correlation coefficient is obtained with respect to two subjective assessments is shown in FIG. 27. For example, as two subjective assessments, the challenge degree and the skill exhibition degree are exemplified. In FIG. 27, the axis of abscissa is a correlation coefficient of the skill exhibition degree and the respective action indexes, that is, a correlation coefficient between the column RRS and another column in FIG. 25. The axis of ordinate is a correlation coefficient of the challenge degree and the respective action indexes. In this example, the degree of concentration is exemplified, and it is assumed that the correlation coefficient of the concentration degree and the skill exhibition degree is 0.1, the correlation coefficient of the concentration degree and the challenge degree is 0.08. In this case, data related to the degree of concentration is plotted at a position of x=0.1, y=0.08. A correlation with more physical data such as acceleration RNSF0 RSNF1 in addition to the defined index such as the degree of concentration is displayed, thereby making it possible to provide a trigger of studying a new action index which is not initially supposed, or becomes important for the first time that an office environment or a business changes.

According to the above display method, a relationship, between the action state of the subjective assessment of a certain worker is easily understood. Also, attention is paid to which data is in which quadrant of a graph, thereby making it possible to determine which action should be extended, or which action should be changed. For example, the action on the first quadrant of the graph causes higher subjective assessment as the action is more. Conversely, the action on the third quadrant of the graph causes better results as the action is less.

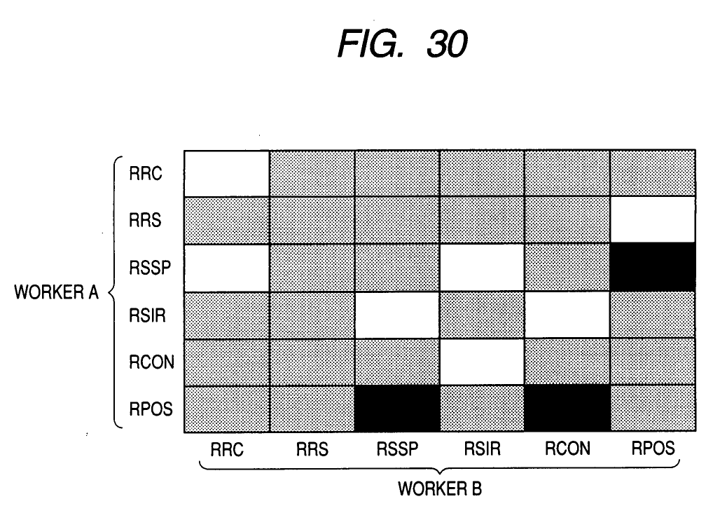

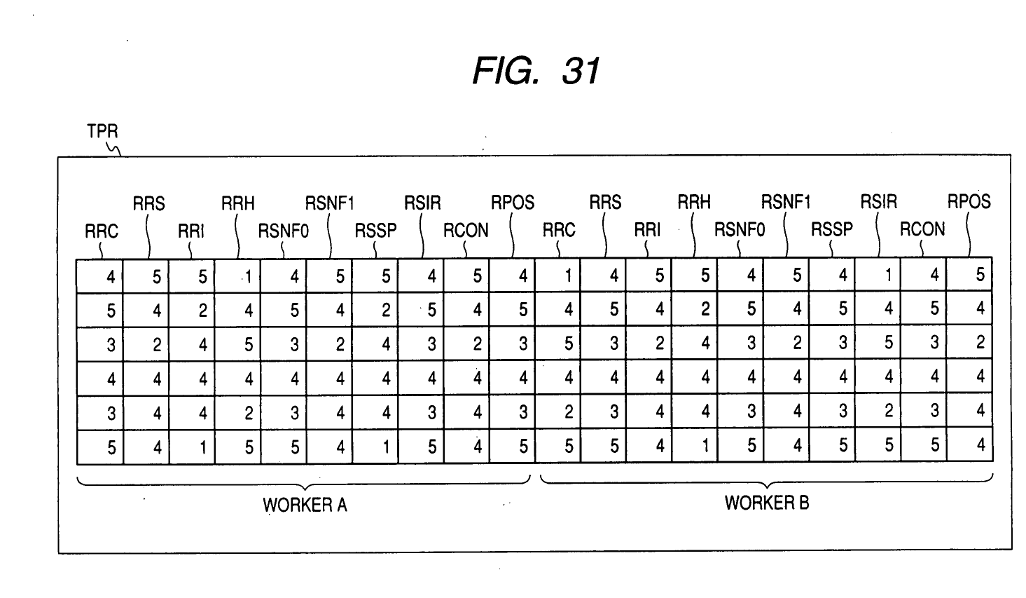

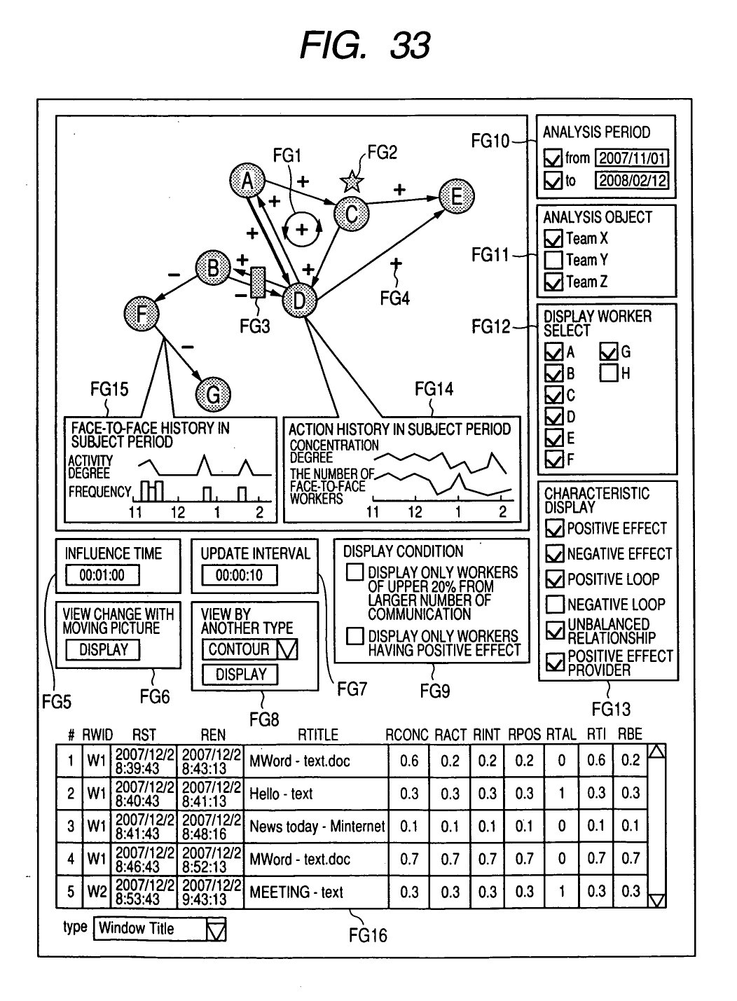

Also, it is possible to display a specific combination of a certain subjective assessment with meaning. For example, a state of a human that concentrates on the activity while exhibiting high skill with respect to a difficult problem (high challenge degree) in psychology is defined as a name of “flow state”. Accordingly, the action on the first quadrant in FIG. 27 can be provided as an action observed in the flow state, or as an action that promotes the flow state. FIG. 30 is a diagram showing the action between the workers A and B, and a relationship between the subject assessments. In order to create this relationship, data is first divided for each of the workers with respect to the action assessment log shown in FIG. 25, and data in the same time zone (for example, the same day) is joined so as to align laterally. This is an action assessment log shown in FIG. 31. Then, the correlation coefficient between the respective two columns between the workers A and B is obtained with respect to the log. For example, a correlation coefficient between the challenge degree RRC of the worker A and the challenge degree RRC of the worker B, and a correlation coefficient between the challenge degree RRC of the worker A and the challenge degree POS of the worker B are obtained. FIG. 30 displays the respective correlation coefficients as matrixes, and the values of correlation with colors. For example, 1×5 of the matrix (most upper and right) represents the correlation coefficient between the challenge degree of the worker A and the positiveness degree of the worker B. In FIG. 30, the color of the respective cells is while when the correlation coefficient is equal to or higher than, for example, a constant value (0.5), black when it is equal to or lower than a constant value (−0.5), and gray when it is other values. With the above display, it is possible to know how the concentration degree of a certain worker affects other workers. Also, in the above example, data in the same time zone are joined together to obtain the correlation coefficient. However, when data at a time shifted by a given period of time is joined together, and the same calculation is conducted (for example, the data of the worker A and the data of the worker B after one hour are joined together), it is possible to obtain an influence of the worker A on the worker B after a given period of time. When shifted conversely (for example, data of the worker A and the data of the worker B before one hour are joined together), it is possible to obtain an influence of the worker B on the worker A after a given period or time. The time difference can be designated by the user through an interface such as FG5 in FIG. 33 which will be described later.

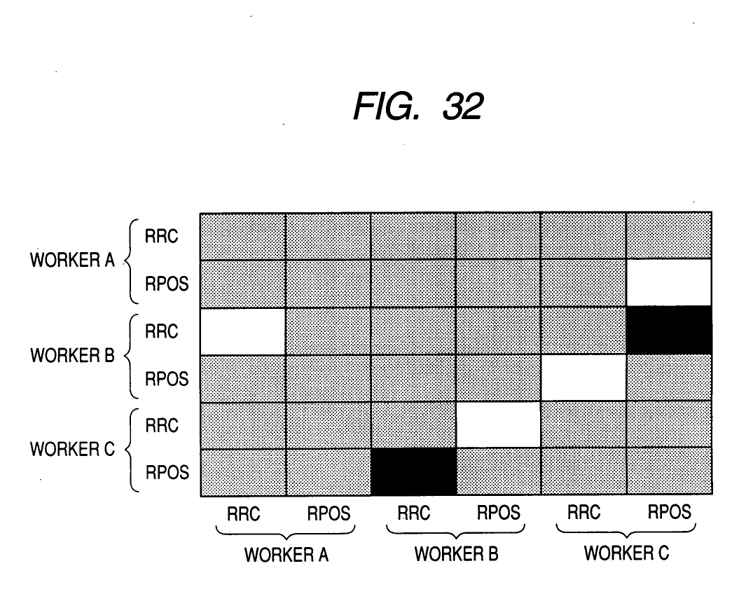

FIG. 30 shows a relationship between two workers. However, the matrix is enlarged and displayed as shown in FIG. 32. As a result, a relationship of three or more workers is displayed, and a worker who has a positive effect on many workers in a group or conversely a worker that adversely affects the workers can be grasped.

Also, it is possible that the respective workers are expressed as nodes, and a value of an influence between the respective two workers is expressed as the weight of connection on the network graph. An example is shown in FIG. 33. In the figure, nodes A to E are workers, respectively. A link between the nodes represents an influence between the workers, which means that a worker being the origin of an arrow affects a worker being the top of the arrow. The magnitude of influence, that is, the magnitude of the above correlation coefficient is expressed as the thickness of the arrow. Also, the type of arrow can be changed according to the type of influence. As an example in the figure, “+” is attached in the positive effect so as to enhance the degree of concentration as with FG4, whereas “−” is attached in the adverse effect so as to deteriorate the degree of concentration.

A desired organization is an organization in which all of the workers are bound by “+”. An issue on the organization, and a point for positive effect can be discriminated by the orientation and number of the influence. For example, among the workers A, C, and D, there is a positive loop such that the worker A has a positive effect on the worker C, the worker C has a positive effect on the worker D, and the worker D has a positive effect on the worker A. It is understood that those three workers desirably cooperate more closely with each other. It is possible that seats close to each other or the same business are assigned to those workers, a positive effect on one worker indirectly promotes a positive effect on two other workers. In the above loop, a loop such as FG1 is located so as to be visually remarkable. On the contrary, it is possible that loops that have negative effect on each other are automatically searched, and the loops are made visually remarkable. The manager who finds out the above loop tries to assign those workers to different businesses, or change a communication manner or frequency between the workers.

In addition, it is possible to find out the unbalanced communication structure from that graph. For example, the workers B and D have such a relationship that the worker D has a positive effect on the worker B, but the worker B has a negative effect on the worker D. Even among three or more workers, the above relationship can occur. In the above relationship, it is not generally understood whether the communication should be increased or decreased. However, the unbalanced relationship is supplied to the manger or the subject worker as with FG3 in the figure, thereby making it possible to analyze the cause or to learn the improvement by mistake.

Also, as another feature of the network, the degree of giving the positive effect on other members by each of the workers can be calculated and visualized. For example, this example shows a method of calculating how many workers the worker has the positive effect on, from the structure of the graph. First, the effect is given to other members by the worker A is investigated. In order to investigate the influence of the workers A and B, a route from the worker A to the worker B is searched, and the number of “−” on the route is counted. When all is “+” and “−” is 0, it can be expected that the worker A has the positive effect on the worker B.

Also, even if there exits “−” actually, the worker A may have the positive effect on the worker B. For example, in the figure, the workers B-F and workers F-G are joined together by “−”, respectively. This means that the states of B and F are reverse, and the states of F and G are opposite, and therefore indirectly means that workers B and G have the same state. That is, even if there is “−”, when the number of “−” is even, the effect is positive. On the other hand, when the number of “−” is add, the effect is negative. When there is no route between the workers A and B, there is no influence. Also, when plural routes are between the workers A and B, and positive effect and negative effect are mixed together, larger one of the positive effect and the negative effect may be determined, or the negative influence may be absolutely determined.

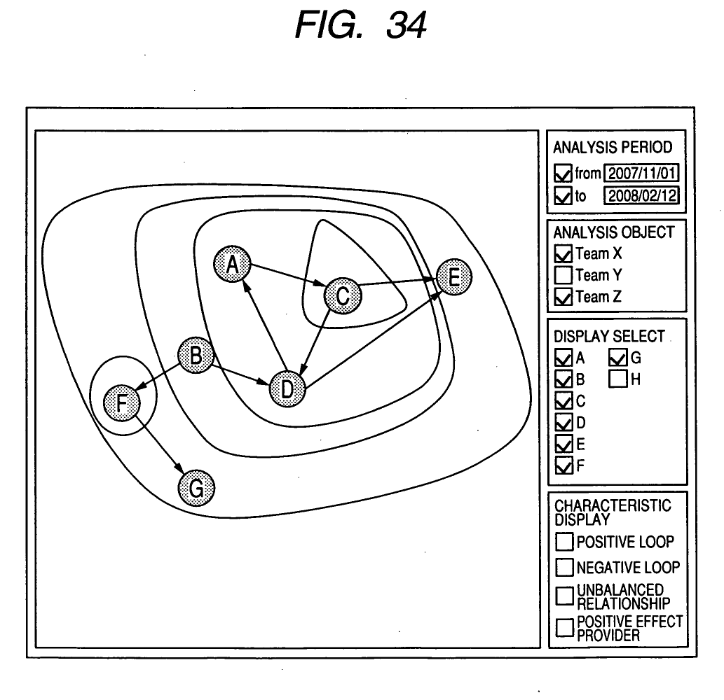

As described above, the influences from the worker A to the respective workers are obtained, and the ratio of the number of positive effects to the number of negative effect is calculated to obtain the degree of influence of the worker A. The calculation is executed with respect to not only the worker A but also all of the workers, and the workers are characteristically displayed, thereby making it easy to know the worker having a positive effect on the organization and the worker having a negative effect on the organization. For example, there are methods in which the worker having the position effect is displayed as with FG2, the workers having the more positive effect are displayed on the upper portion of a screen, and the workers having the more positive effect are displayed on the upper portion of a mountain by means of a display method of FIG. 34 showing the contour of a map.

Also, an interface that sets the subject period is provided as with FG10, and only data in a period designated by the user is to be processed, thereby making it possible to display only a period which is particularly interested by the user.

Also, as described above, it is possible to obtain how much another worker is affected after a given period of time elapses since the action of a certain worker. For example, the interface that designates a time as with FG5 is provided, and when a time is designated by the user, data of a certain worker and data of another worker after a delay time designated by the user are joined together to obtain the degree of influence. As a result, it is possible to display the influence after the given period of time has elapsed.

Also, an interface that designates a group to be analyzed as with FG11 is provided, and only a group designated by the user is to be processed, thereby making it possible to display only the group particularly interested by the user.

Also, an interface that designates a group to be analyzed as with FG12 is provided, and only a worker designated by the user is to be processed, thereby making it possible to display only the worker particularly interested by the user.

Also, an interface that designates a feature to be displayed with emphasis as with FG13 is provided, and only a feature designated by the user is displayed as with FG1, FG2, FG3, or FG4, thereby making it possible to display only the feature particularly interested by the user.

An interface that designates whether a change in the network graph is displayed by a moving picture as with FG6, or not, is provided, and designation can be made by the user so as to display the change in the network graph during the period by the moving picture.

Also, a network graph shown in FIG. 33 can be updated in real time in conformity with the sensor data sequentially transmitted and the subjective assessment data. The frequency of update can be designated by the user through the interface with FG7.

A button FG8 is to select the display of another view as shown in FIG. 34.

Also, the condition of an operator to be displayed is selected as with FG9, thereby making it possible to directly provide information that a user wishes to watch. For example, only the worker larger in the number of communication is displayed, or only the worker having the positive effect is displayed.

FG16 is a history of the quality of activity described with reference to FIG. 14, and the history is displayed together, thereby making it possible to view the activity and quality of the worker which are interested by the user in the network graph.

Also, FG14 is an interface that displays the quality of activity of the worker and the value of a sensor which are selected in the figure, and displays how the quality assessment value such as the above degree of concentration, or the value of the sensor such as the number of face-to-face workers changes during the period with a line graph. Likewise, FG15 is an interface that visualizes a change in the communication between two workers, and displays how the activity and the number of face-to-face between two workers change in the period with a line graph. As a result, the user make it easy to analyze the actions of the respective workers.

The embodiments of the present invention have been described above, but the present invention is not limited to the above embodiments, and can be variously modified, and it would be understood by the ordinary skilled person that the above respective embodiments can be appropriately combined together.

What is claimed is:

1. A server comprising:
an external communication unit that receives sensor data acquired from a sensor by a sensor node and activity information for a computer operated by a worker;
an activity quality assessment unit that calculates an action index indicative of an action state of the worker according to the sensor data;
an activity specification unit that specifies the activity of the worker according to the activity information; and
an activity quality calculation unit that associates the action index with the specified activity as activity quality information representative of the quality of the activity.

2. The server according to claim 1,
wherein the activity quality calculation unit extracts a time interval of the specified activity, calculates a time average of the action index of the time interval to calculate the activity quality information, and creates an activity quality list that associates the specified activity with the activity quality information.

3. The server according to claim 2, further comprising an activity quality visualization unit that outputs the activity quality list to a display unit connected to the server.

4. The server according to claim 1,
wherein the action state comprises at least one of the degree of concentration, the activity degree, the face-to-face frequency, the positiveness degree, the degree of statement, the degree of cohesion, and the betweenness of the worker.

5. The server according to claim 2,
wherein the server includes an identifier management table that stores a correspondence relationship of an identifier of the worker, an identifier of the sensor node, and an identifier of the computer, and
wherein the activity quality calculation unit creates the activity quality list with reference to the identifier management table.

6. The server according to claim 1,
wherein the external communication unit receives the number of transmission of mails transmitted from the computer, and
wherein the activity quality assessment unit calculates the face-to-face frequency of a plurality of workers on the basis of the sensor data and the number of mail transmission, and creates a network graph of the plurality of workers on the basis of the face-to-face frequency.

7. The server according to claim 1,
wherein information indicative of a subjective assessment of the worker is acquired, and
wherein the information indicative of the acquired subjective assessment of the worker is stored in association with the action index.

8. The server according to claim 7,
wherein the information indicative of the subjective assessment of the worker is input by the worker through the sensor node on the basis of a signal output at a given time by the sensor node, and
wherein a relationship between a frequency of acceleration obtained from the sensor data at the given time and the subjective assessment, or a correlation relationship between the action index and the subjective assessment is obtained.

9. The server according to claim 8,
wherein the signal is output on the basis of a command transmitted to the sensor node from the server when a specific action state is detected.

10. A sensor net system, comprising:
a sensor node including a sensor and a wireless transceiver unit that transmits the sensor data acquired by the sensor;
a base station that is connected to the server on a network and transmits the received sensor data to the server; and
a server including an external communication unit that receives the sensor data and activity information from a computer operated by a worker, an activity quality assessment unit that calculates an action index indicative of an action state of the worker according to the sensor data, an activity specification unit that specifies the activity of the worker according to the activity information, and an activity quality calculation unit that associates the action index with the specified activity as activity quality information representative of the quality of the activity.

11. The sensor net system according to claim 10,
wherein the activity quality calculation unit extracts a time interval of the specified activity, calculates a time average of the action index of the time interval to calculate the activity quality information, and creates an activity quality list that associates the specified activity with the activity quality information.

12. The sensor net system according to claim 11, further comprising an activity quality visualization unit that outputs the activity quality list to a display unit connected to the server.

13. The sensor net system according to claim 10,
wherein the action state comprises at least one of the degree of concentration, the activity degree, the face-to-face frequency, the positiveness degree, the degree of speed, the degree of cohesion, and the betweenness of the worker.

14. The sensor net system according to claim 11,
wherein the server further includes an identifier management table that stores a correspondence relationship of an identifier of the worker, an identifier of the sensor node, and an identifier of the computer, and
wherein the activity quality calculation unit creates the activity quality list with reference to the identifier management table.

15. The sensor net system according to claim 10,
wherein the external communication unit receives the number of transmission of mails transmitted from the computer, and
wherein the activity quality assessment unit calculates the face-to-face frequency of a plurality of workers on the basis of the sensor data and the number of mail transmission, and creates a network graph of the plurality of workers on the basis of the face-to-face frequency.

16. The sensor net system according to claim 10, further comprising a relay terminal which is connected to the base station wirelessly,
wherein the sensor node is connected to the base station or the relay terminal wirelessly,
wherein the relay terminal transmits a time setting command based on the latest time of the relay terminal to the sensor node that transmits the command transmission request when the relay terminal receives a command transmission request transmitted by the sensor node, and
wherein the sensor node sets a time on the basis of the latest time of the relay terminal when the sensor node receives the time setting command.

17. The sensor net system according to claim 16,
wherein the computer communicates with a standard bureau that manages the present time to set a time in conformity with a time setting of the sensor node.

18. The sensor net system according to claim 10,
wherein the server acquires information indicative of a subjective assessment of the worker, and stores the acquired information indicative of the subjective assessment of the worker in association with the action index.

19. The sensor net system according to claim 18,
wherein the sensor node outputs a signal at a given time,
wherein the information indicative of the subjective assessment of the worker is input through the sensor node by the worker on the basis of the signal, and
wherein the server obtains a relationship between the frequency of acceleration calculated on the basis of the sensor data at the given time and the subjective assessment, or a correlation relationship between the action index and the subjective assessment.

20. The sensor net system according to claim 19,
wherein the server transmits a command to the sensor node when a specific action state is detected, and
wherein the sensor node outputs the signal on the basis of the command.
